(19) United States
(12) Patent Application Publication
(10) Pub. No.: US 2012/0153806 A1
(43) Pub. Date: Jun. 21, 2012

(54) ELECTRODE FOR DISCHARGE LAMP, METHOD OF MANUFACTURING ELECTRODE FOR DISCHARGE LAMP, AND DISCHARGE LAMP

(75) Inventors: Kazuhiro Ito, Tokyo (JP); Satoru Watanabe, Tokyo (JP); Naomichi Miyakawa, Tokyo (JP); Yutaka Kuroiwa, Tokyo (JP); Setsuro Ito, Tokyo (JP)

(73) Assignee: Asahi Glass Company, Limited, Tokyo (JP)

(21) Appl. No.: 13/404,870

(22) Filed: Feb. 24, 2012

Related U.S. Application Data
(63) Continuation of application No. PCT/JP10/64315, filed on Aug. 24, 2010.

(30) Foreign Application Priority Data
Aug. 25, 2009 (JP) 2009-194859

(51) Int. Cl. H01J 61/06; H01J 9/12; H01B 1/08; H01J 1/02

(52) U.S. Cl. 313/491; 313/311; 445/51; 252/518.1

(57) ABSTRACT

An electrode for a discharge lamp is provided with a mayenite compound in at least a part of the electrode that emits secondary electrons, and a surface of a surface layer of the mayenite compound is plasma treated.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP2010/064315 filed on Aug. 24, 2010, which is based upon and claims the benefit of priority of the prior Japanese Patent Application No. 2009-194859 filed on Aug. 25, 2009, the entire contents of which are incorporated herein by reference.

### BACKGROUND OF THE INVENTION

1. Field of the Invention

The present invention relates to discharge lamps, and to cold cathode fluorescent lamps in particular. More particularly, the present invention relates to an electrode for a discharge lamp, a method of manufacturing the electrode for the discharge lamp, and the discharge lamp, that includes a plasma treated mayenite compound in at least a part of the electrode or at a suitable location inside the cold cathode fluorescent lamp in order to reduce a cathode fall voltage and reduce power consumption, and to further improve a resistance to sputtering, so that a longer life may be achieved.

2. Description of the Related Art

A liquid crystal display (LCD) used in flat panel displays, personal computers, and the like has a built-in back light that uses a cold cathode fluorescent lamp as a light source to illuminate the LCD. FIG. 44 illustrates a structural diagram of a conventional cold cathode fluorescent lamp.

In FIG. 44, a glass tube 1 of a cold cathode fluorescent lamp 10 has an internal surface coated with a phosphor 3, and is sealed in a state in which a discharge gas such as argon (Ar), neon (Ne) and mercury (Hg) for exciting phosphor is introduced inside the glass tube 1. A pair of electrodes 5A and 5B following cup-shaped cold cathodes is arranged symmetrically inside the glass tube 1, and one end of each of lead wires 7A and 7B is fixed to an end of corresponding electrodes 5A and 5B, while the other end of each of the lead wires penetrates the glass tube 1.

Conventionally, the materials generally used for the cup-shaped cold cathode are nickel metal (Ni), molybdenum (Mo), tungsten (W), niobium (Nb), and the like. Amongst these materials, molybdenum is useful for an electrode that may reduce the cathode fall voltage but is expensive. Hence recently, a performance equivalent to that of molybdenum is obtained by coating an alkaline metal compound such as cesium (Cs) or an alkaline earth metal compound or the like on nickel which is inexpensive.

The cold cathode fluorescent lamp 10 emits light by glow discharge. The glow discharge occurs due to the a effect of ionization of gas molecules caused by electrons moving between the cathode and the anode, and the y effect of the so-called secondary electron emission of electrons that are emitted when positive ions of argon, neon, mercury, and the like collide with the negative electrode. In the case of the glow discharge, the positive ion density of argon, neon, mercury and the like becomes high in a cathode fall part which is a discharge part of the cathode side, and a “cathode fall voltage” phenomenon in which the voltage falls at the cathode fall part occurs.

The cathode fall voltage does not contribute to the light emission of the lamp, and as a result, this voltage causes an operating voltage to become high and the luminous efficacy to deteriorate.

In addition, there are demands to develop an electrode for cold cathode that may reduce the cathode fall voltage, with respect to recent market demands to increase the length of the cold cathode fluorescent lamps and to increase the luminance by driving with a large current.

The cathode fall voltage is related to the secondary electron emission described above, and depends upon the secondary electron emission coefficient of the cold cathode material that is selected. The secondary electron emission coefficient of the cold cathode metal material is 1.3 for nickel, 1.27 for molybdenum, and 1.33 for tungsten. Generally, the cathode fall voltage may be made lower by making the secondary electron emission coefficient larger, but because the secondary electron emission is greatly affected by the surface condition, a difference between the cathode fall voltages for nickel and molybdenum is difficult to judge.

As described above, molybdenum may form a cold cathode with reduced cathode fall voltage. Examples of materials that have secondary electron emission coefficients larger than that of molybdenum include metal iridium (Ir) and platinum (Pt). The secondary electron emission coefficient is 1.5 for iridium and 1.44 for platinum. In a Japanese Laid-Open Patent Publication No. 2008-300043, an alloy of iridium and rhodium (Rh) is used in order to reduce the cathode fall voltage, however, the reduction is only on the order of 15% at most with respect to the cathode fall voltage for a case in which molybdenum is used.

In addition, the cold cathode fluorescent lamp has a problem in that ions of argon or the like generated during the glow discharge collide with the electrode, and causes wear of the cup electrode by sputtering. A sufficient amount of electrons may not be emitted as the cup electrode wears out, to thereby reduce the luminance. Accordingly, there is a problem in that the life of the electrode is shortened to shorten the life of the cold cathode fluorescent lamp.

In order to solve such problems, proposals have been made to coat the cup electrode surface with a material having resistance to sputtering, but there is a problem in that the performance of the secondary electron emission from the cup electrode deteriorates. For this reason, there are demands for a material having resistance to sputtering and enabling high performance of the secondary electron emission.

### SUMMARY OF THE INVENTION

The present invention is conceived in view of the above problems of the prior art, and one object is to provide an electrode for discharge lamp, a method of manufacturing the electrode for discharge lamp, and a discharge lamp, according to which a plasma treated mayenite compound may be included in at least a part of the electrode or at a suitable location inside a cold cathode fluorescent lamp in order to reduce a cathode fall voltage and reduce power consumption, and to further improve a resistance to sputtering, so that a longer life may be achieved.

An electrode for a discharge lamp according to the present invention may include a mayenite compound in at least a part of the electrode emitting secondary electrons, wherein a surface of a surface layer of the mayenite compound is plasma treated.

In the electrode for the discharge lamp of the present invention, the electrode may include a metal base, and the mayenite compound may be provided in at least a part of the metal base.

In addition, in the electrode for the discharge lamp of the present invention, at least a part of the electrode may be formed by a sintered body of the mayenite compound, at least a part of free oxygen ions of the mayenite compound may be substituted by electrons, and an electron density may be 1×10¹⁹ cm⁻³ or higher. Moreover, in the electrode for the discharge lamp of the present invention, the surface of the surface layer of the mayenite compound may be plasma treated by plasma generated by discharge.

Further, in the electrode for the discharge lamp of the present invention, the surface of the surface layer of the mayenite compound may be plasma treated by plasma of at least one kind of gas selected from a group consisting of noble gas and hydrogen or, by plasma of a mixed gas of mercury gas and at least one kind of gas selected from a group consisting of a noble gas and hydrogen.

In addition, in the electrode for the discharge lamp of the present invention, the mayenite compound may include a 12CaO—7Al₂O₃ compound, a 12SrO—7Al₂O₃ compound, a mixed crystal compound of those, or an isomorphic compound of those.

Moreover, in the electrode for the discharge lamp of the present invention, at least a part of free oxygen ions forming the mayenite compound may be substituted by anions of atoms having an electron affinity smaller than that of the free oxygen ions.

Further, in the electrode for the discharge lamp of the present invention, the anions of the atoms having the electron affinity smaller than that of the free oxygen ions may be hydride ions H.

In addition, in the electrode for the discharge lamp of the present invention, a H⁻ ion density of the hydride ions H⁻ may be 1×10¹⁵ cm⁻³ or higher.

Moreover, a method of manufacturing an electrode for a discharge lamp of the present invention may include forming a part of the electrode or the electrode in its entirety by a mayenite compound, and thereafter plasma treating a surface of a surface layer of the mayenite compound of the electrode.

Further, a discharge lamp of the present invention may include the electrode for the discharge lamp as described above or, the electrode for the discharge lamp manufactured by the method of manufacturing the electrode for the discharge lamp as described above.

In addition, a discharge lamp of the present invention includes an fluorescent tube, a discharge gas sealed inside the fluorescent tube, and a mayenite compound in contact with the discharge gas and arranged in at least a part inside the fluorescent tube, wherein a surface of a surface layer of the mayenite compound is plasma treated.

### BRIEF DESCRIPTION OF THE DRAWINGS

FIG. 1 is a structural diagram of an embodiment of the present invention;

FIG. 2 is a diagram for explaining an open cell discharge measuring apparatus;

FIGS. 3(a) and 3(b) illustrate an example of a case in which a mayenite compound is coated on an electrode;

FIGS. 4(a) and 4(b) illustrate an example of the case in which the mayenite compound is coated on the electrode;

FIGS. 5(a) and 5(b) illustrate an example of the case in which the mayenite compound is coated on the electrode;

FIGS. 6(a) and 6(b) illustrate an example of the case in which the mayenite compound is coated on the electrode;

FIGS. 7(a) and 7(b) illustrate an example of the case in which the mayenite compound is coated on the electrode;

FIGS. 8(a) and 8(b) illustrate an example of the case in which the mayenite compound is coated on the electrode;

FIGS. 9(a) and 9(b) illustrate an example of the case in which the mayenite compound is coated on the electrode;

FIGS. 10(a) and 10(b) illustrate an example of the case in which the mayenite compound is coated on the electrode;

FIGS. 11(a) and 11(b) illustrate an example of the case in which the mayenite compound is coated on the electrode;

FIGS. 12(a) and 12(b) illustrate an example of the case in which the mayenite compound is coated on the electrode;

FIGS. 13(a) and 13(b) illustrate an example of the case in which the mayenite compound is coated on the electrode;

FIGS. 14(a) and 14(b) illustrate an example of the case in which the mayenite compound is coated on the electrode;

FIGS. 15(a) and 15(b) illustrate an example of the case in which the mayenite compound is coated on the electrode;

FIGS. 16(a) and 16(b) illustrate an example of the case in which the mayenite compound is coated on the electrode;

FIGS. 17(a) and 17(b) illustrate an example of the case in which the mayenite compound is coated on the electrode;

FIG. 18 illustrates an example of the case in which the mayenite compound is coated on the electrode;

FIG. 19 illustrates an example of the case in which the mayenite compound is coated on the electrode;

FIG. 20 illustrates an example of the case in which the mayenite compound is coated on the electrode;

FIGS. 21(a)-21(c) illustrate an example of the case in which the mayenite compound is coated on the electrode;

FIGS. 22(a)-22(c) illustrate an example of the case in which the mayenite compound is coated on the electrode;

FIGS. 23(a)-23(c) illustrate an example of the case in which the mayenite compound is coated on the electrode;

FIGS. 24(a) and 24(b) illustrate an example of the case in which the mayenite compound is coated on the electrode;

FIGS. 25(a) and 25(b) illustrate an embodiment of an electrode formed by a sintered body of a mayenite compound;

FIGS. 26(a) and 26(b) illustrate an embodiment of the electrode formed by the sintered body of the mayenite compound;

FIGS. 27(a) and 27(b) illustrate an embodiment of the electrode formed by the sintered body of the mayenite compound;

FIGS. 28(a) and 28(b) illustrate an embodiment of the electrode formed by the sintered body of the mayenite compound;

FIGS. 29(a) and 29(b) illustrate an embodiment of the electrode formed by the sintered body of the mayenite compound;

FIGS. 30(a) and 30(b) illustrate an embodiment of the electrode formed by the sintered body of the mayenite compound;

FIGS. 31(a) and 31(b) illustrate an embodiment of the electrode faulted by the sintered body of the mayenite compound;

FIGS. 32(a) and 32(b) illustrate an embodiment of the electrode formed by the sintered body of the mayenite compound;

FIGS. 33(a) and 33(b) illustrate an embodiment of the electrode formed by the sintered body of the mayenite compound;

FIGS. 34(a) and 34(b) illustrate an embodiment of the electrode formed by the sintered body of the mayenite compound;

FIGS. 35(a) and 35(b) illustrate an embodiment of the electrode formed by the sintered body of the mayenite compound;

FIG. 36 illustrates an embodiment of the electrode formed by the sintered body of the mayenite compound;

FIG. 37 illustrates an embodiment of the electrode formed by the sintered body of the mayenite compound;

FIGS. 38(a)-38(c) illustrate an embodiment of the electrode formed by the sintered body of the mayenite compound;

FIGS. 39(a)-39(c) illustrate an embodiment of the electrode formed by the sintered body of the mayenite compound;

FIGS. 40(a)-40(c) illustrate an embodiment of the electrode formed by the sintered body of the mayenite compound;

FIG. 41 is a diagram illustrating measured results of the cathode fall voltage for a sample A of a practical example;

FIG. 42 is a diagram illustrating measured results of the cathode fall voltage for a sample B of a practical example;

FIG. 43 is a diagram illustrating measured results of the cathode fall voltage for a sample C of a practical example;

FIG. 44 is a structural diagram of a conventional cold cathode fluorescent lamp;

FIG. 45 is a diagram illustrating measured results of the cathode fall voltage for a sample F of a practical example;

FIG. 46 is a diagram illustrating measured results of the cathode fall voltage for a sample G of a practical example;

FIG. 47 is a diagram illustrating measured results of the cathode fall voltage for a sample L of a practical example;

FIG. 48 is a diagram illustrating measured results of the discharge firing voltage and the cathode fall voltage for a sample M of a practical example when a product of a gas pressure P and an inter-electrode distance d is varied; and

FIG. 49 is a diagram illustrating measured results of the cathode fall voltage for the sample M of a practical example.

### DESCRIPTION OF THE PREFERRED EMBODIMENTS

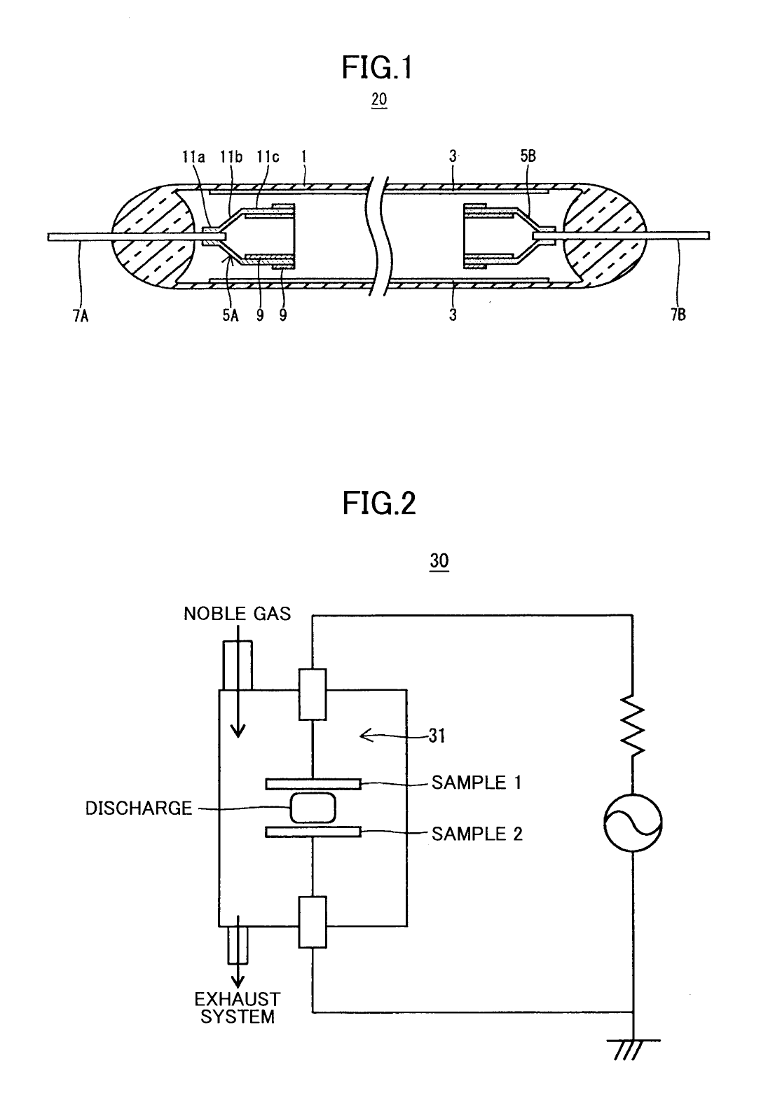

A description will hereinafter be given of embodiments of the present invention. FIG. 1 is a structural diagram of an embodiment of the present invention. FIG. 1 illustrates a cold cathode fluorescent lamp as an example of a discharge lamp to which the present invention may suitably be applied. In the cold cathode fluorescent lamp, an electrode for the discharge lamp corresponds to a cold cathode.

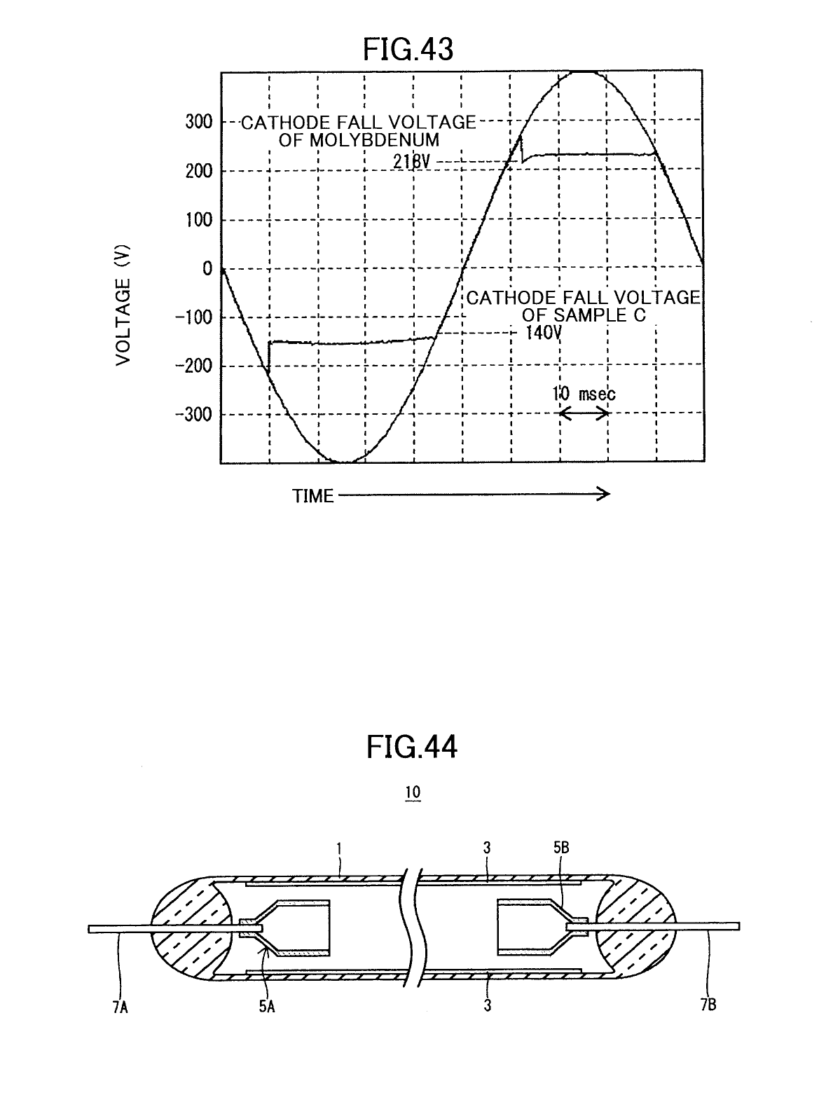

In FIG. 1, those elements that are the same as those corresponding parts in FIG. 44 are designated by the same reference numerals, and a description thereof will be omitted.

In FIG. 1, electrodes 5A and 5B of a cold cathode fluorescent lamp 20 are held around respective lead wires 7A and 7B by holding parts 11a of the electrodes 5A and 5B. The electrodes 5A and 5B have a conical bottom part 11b that spreads in a conical shape from the holding part 11a, and a cylindrical part 11c that extends towards a discharge space from the conical bottom part 11b.

An inner side and an outer side of the cylindrical part 11c is coated by a mayenite compound 9 having a surface of a surface layer thereof that has been plasma treated. In this embodiment, the cup-shaped cold cathode is coated with the mayenite as an example. However, the shape of the electrode may be such that a tip end part of the cup has a hemispherical shape, and further, the electrode may have shapes other than the cup shape, including a strip shape, a tubular shape, a rod shape, a wire shape, a coil shape, and a hollow shape.

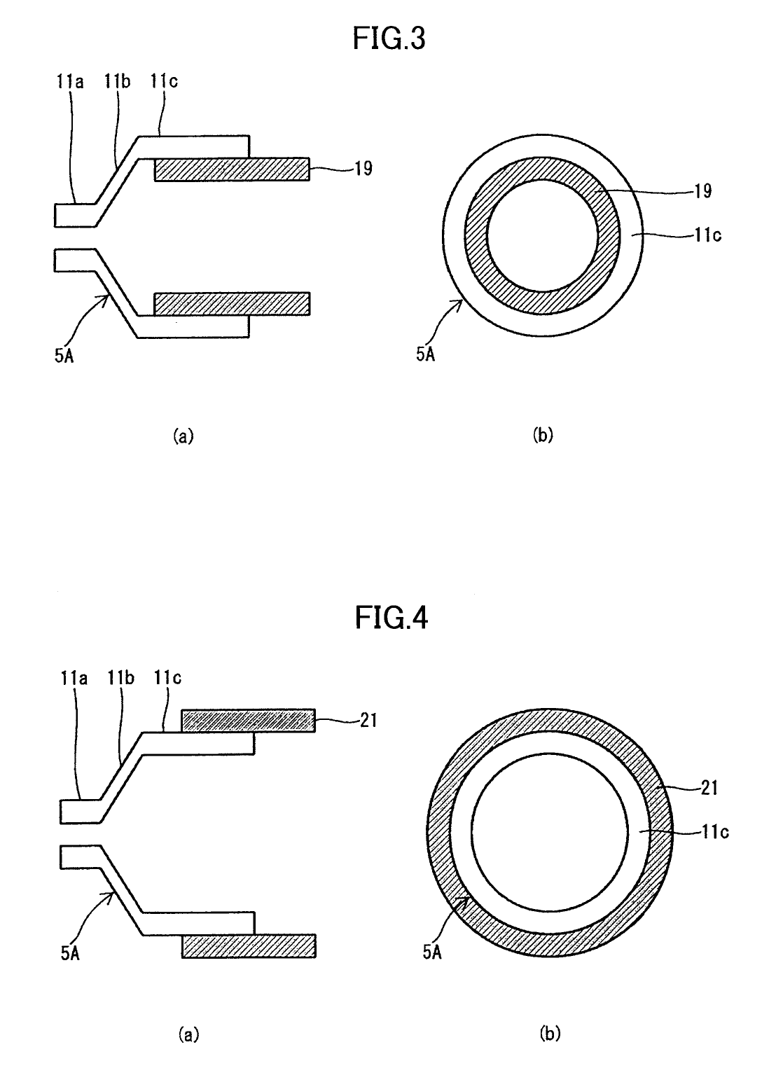

Examples of cases in which the mayenite is coated on the electrodes 5A and 5B are illustrated in FIG. 3(a)-FIG. 24(b).

First, a description will be given of cases in which the electrodes 5A and 5B have the cup shape.

FIG. 3(a) illustrates a front cross sectional view and FIG. 3(b) illustrates a side view of the cup-shaped electrode. In FIG. 3, a mayenite compound 19 is coated in a cylindrical manner on an inner peripheral surface of the cylindrical part 11c. The mayenite compound 19 may project from the cup as illustrated in FIG. 3(a).

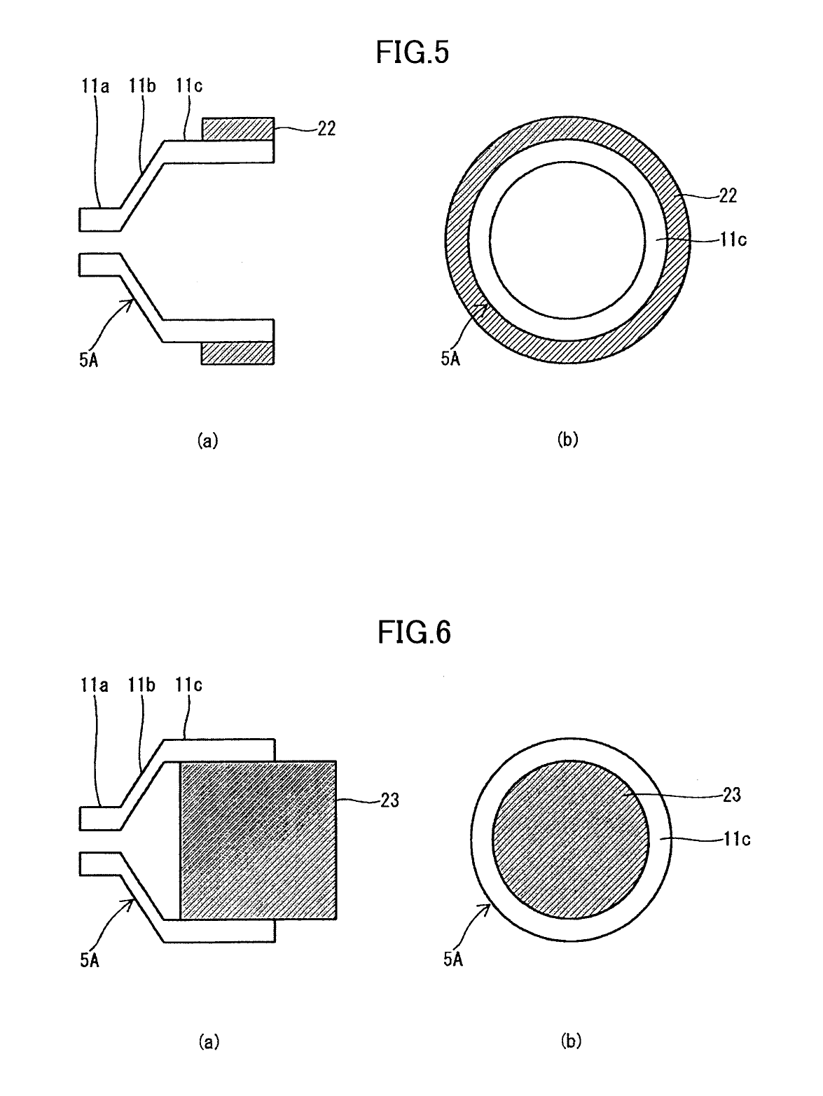

A mayenite compound 21 may be coated in a cylindrical manner on an outer peripheral surface of the cylindrical part 11c, as illustrated in FIGS. 4(a) and 4(b). In this case, the mayenite compound 21 may project from the cup as illustrated in FIG. 4(a) or, the mayenite compound 22 may aligned to the end of the cup so as not to project from the cup as illustrated in FIG. 5(a).

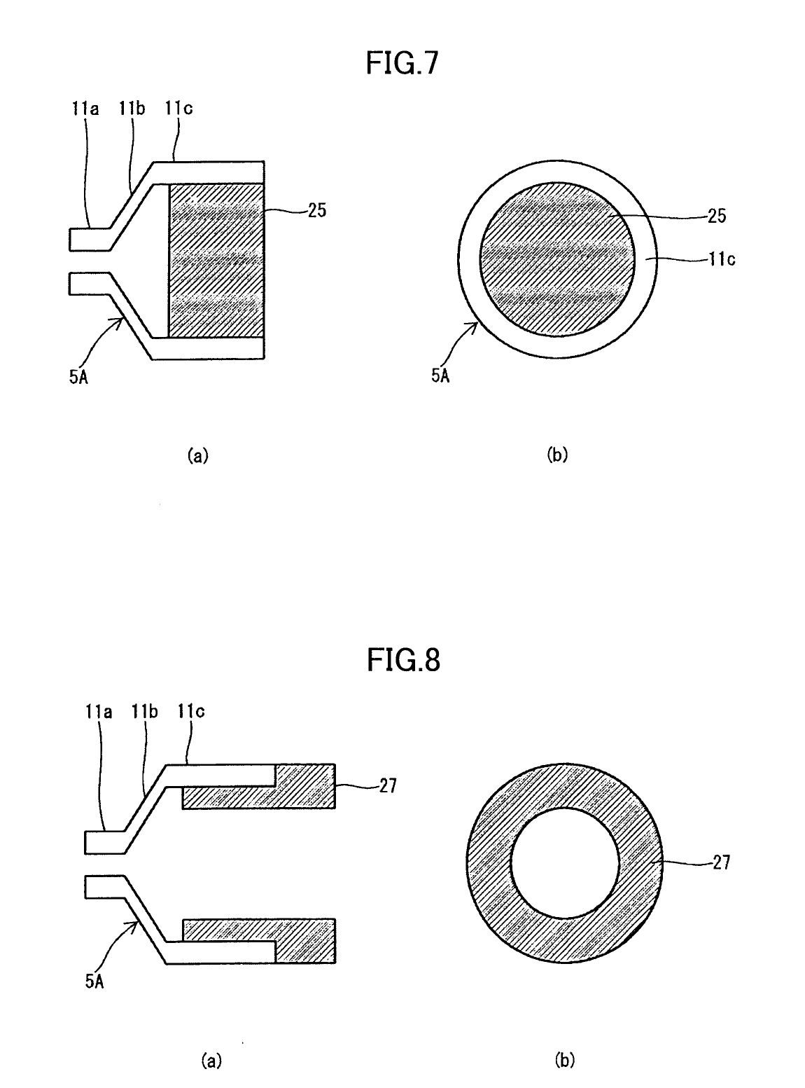

Further, a cylindrical mayenite compound 23 may be inserted into the cylindrical part 11c so as to partially project from the cylindrical part 11c as illustrated in FIGS. 6(a) and 6(b) or, a cylindrical column-shaped mayenite compound 25 may be accommodated within the cylindrical part 11c as illustrated in FIGS. 7(a) and 7(b).

Moreover, a projecting portion of a mayenite compound 27 may have a cylindrical shape with a diameter that is larger than that of a cylindrical portion inserted into the cylindrical part 11c, as illustrated in FIGS. 8(a) and 8(b).

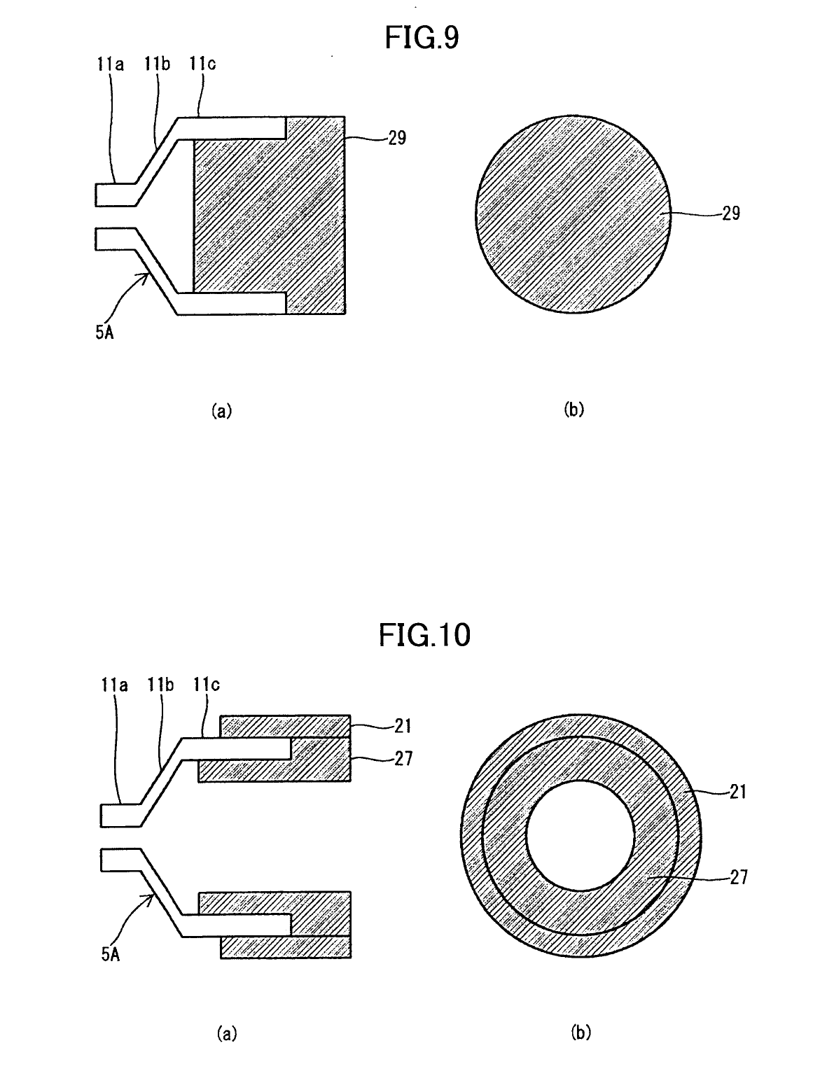

In addition, a projecting portion of a mayenite compound 29 may have a cylindrical column shape with a diameter that is larger than that of a cylindrical column portion that is inserted into the cylindrical part 11c, as illustrated in FIGS. 9(a) and 9(b).

Further, the mayenite compound 27 and the mayenite compound 21 may be combined, as illustrated in FIGS. 10(a) and 10(b).

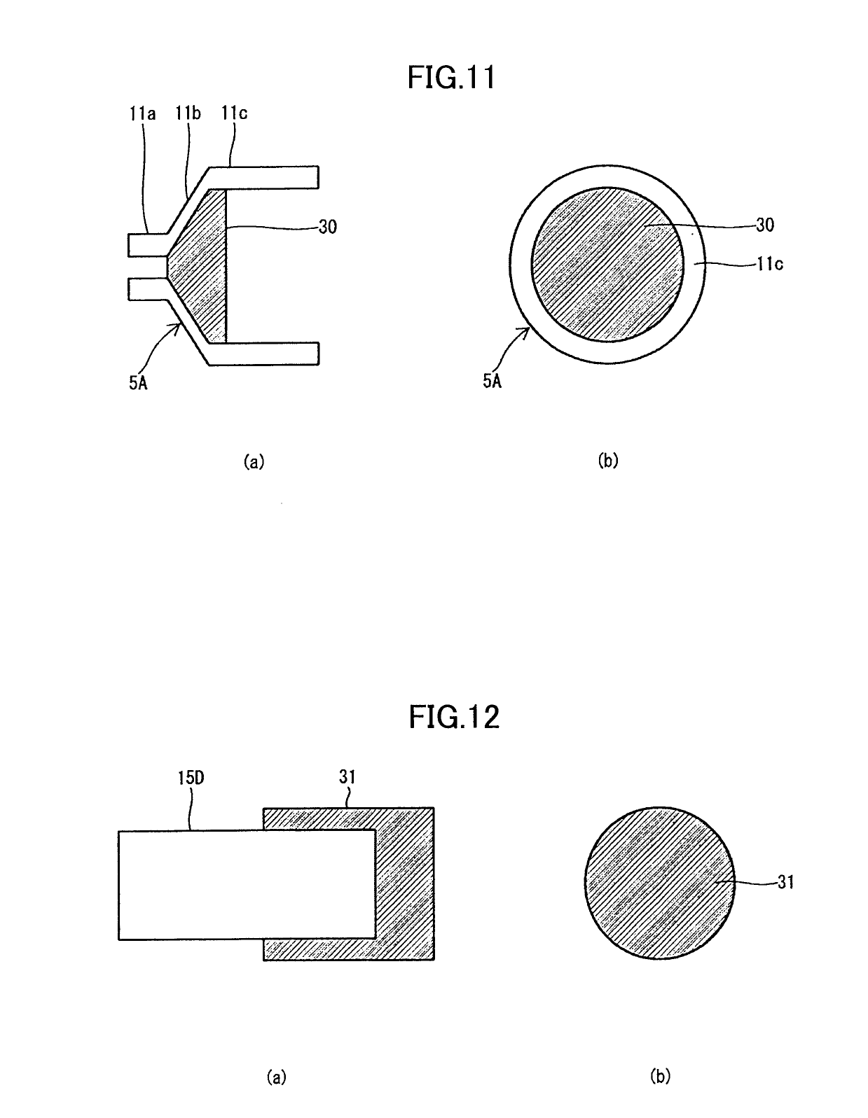

Moreover, a mayenite compound 30 may be accommodated in an inner side of the conical bottom part 11b, as illustrated in FIGS. 11(a) and 11(b).

Next, a description will be given of cases in which the electrode has a rod shape or a cylindrical column shape.

FIGS. 12(a) and 12(b) illustrate an example in which a tip end part of a rod shaped or cylindrical column-shaped electrode 15D is coated with a mayenite compound 31 to a cylindrical shape with a covered bottom so that an outer periphery and a head portion of the electrode 15D will not be exposed.

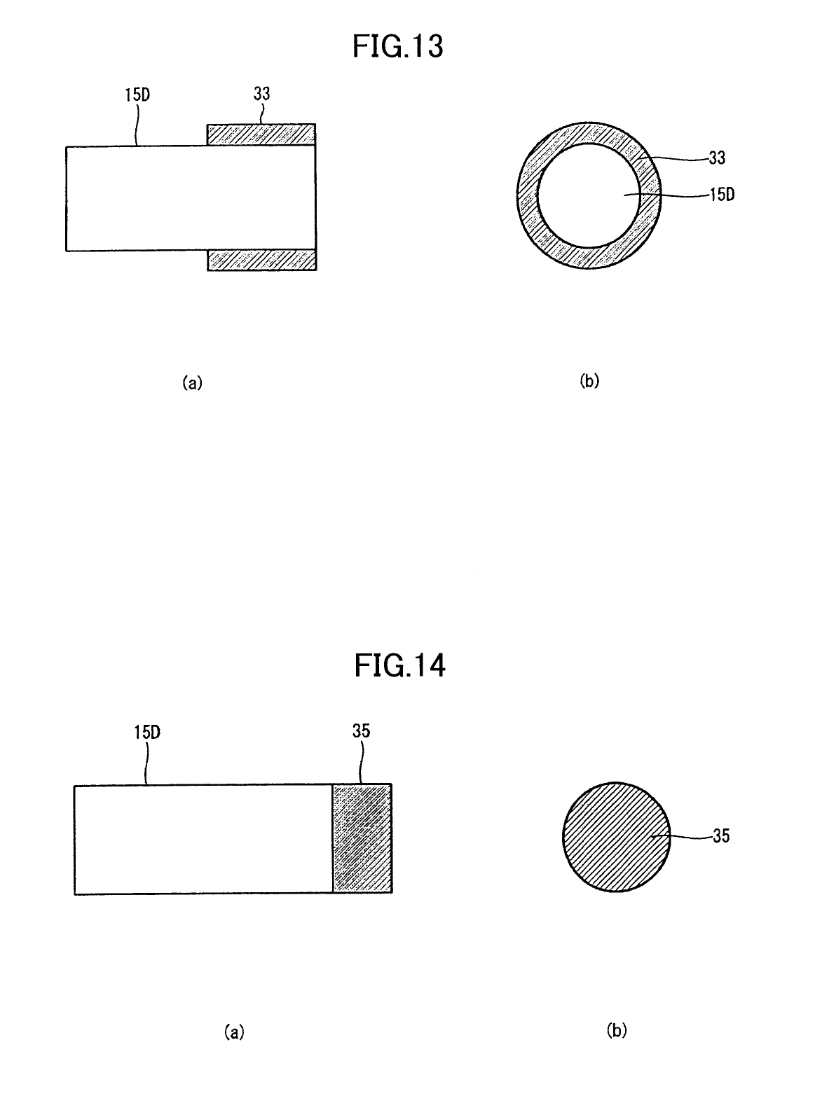

In addition, FIGS. 13(a) and 13(b) illustrate an example in which a mayenite compound 33 is coated only on a tip end outer periphery of the electrode 15D.

Further, FIGS. 14(a) and 14(b) illustrate an example in which a mayenite compound 35 is coated only on the tip end head portion of the electrode 15D by matching the diameter of the mayenite compound 35 to that of the electrode 15D.

Moreover, FIGS. 15(a) and 15(b) illustrate an example in which a mayenite compound 37 is coated only on the tip end head portion of the electrode 15D to protrude from the tip end head portion by exceeding the diameter of the electrode 15D.

Next, a description will be given of cases in which the electrode has a wire shape.

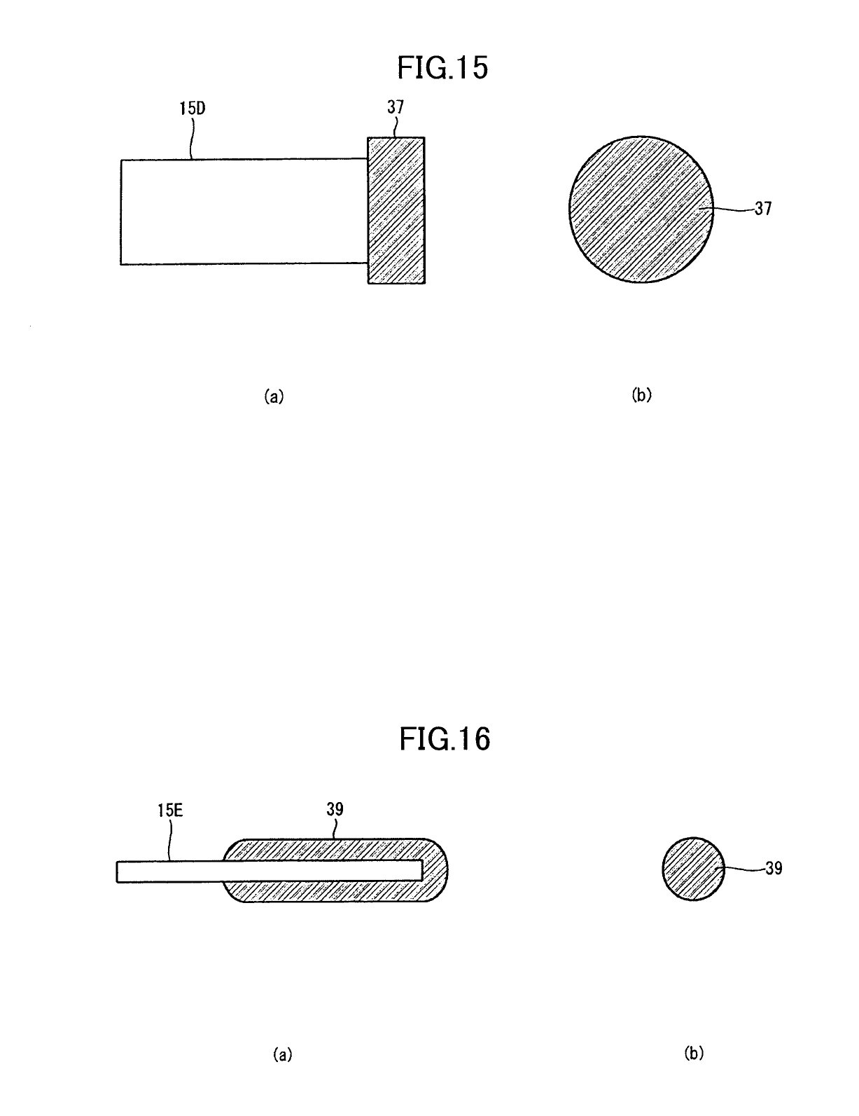

FIGS. 16(a) and 16(b) illustrate an example in which a mayenite compound 39 coats a tip end part of a wire-shaped electrode 15E so that an outer periphery and a head portion of the electrode 15E will not be exposed.

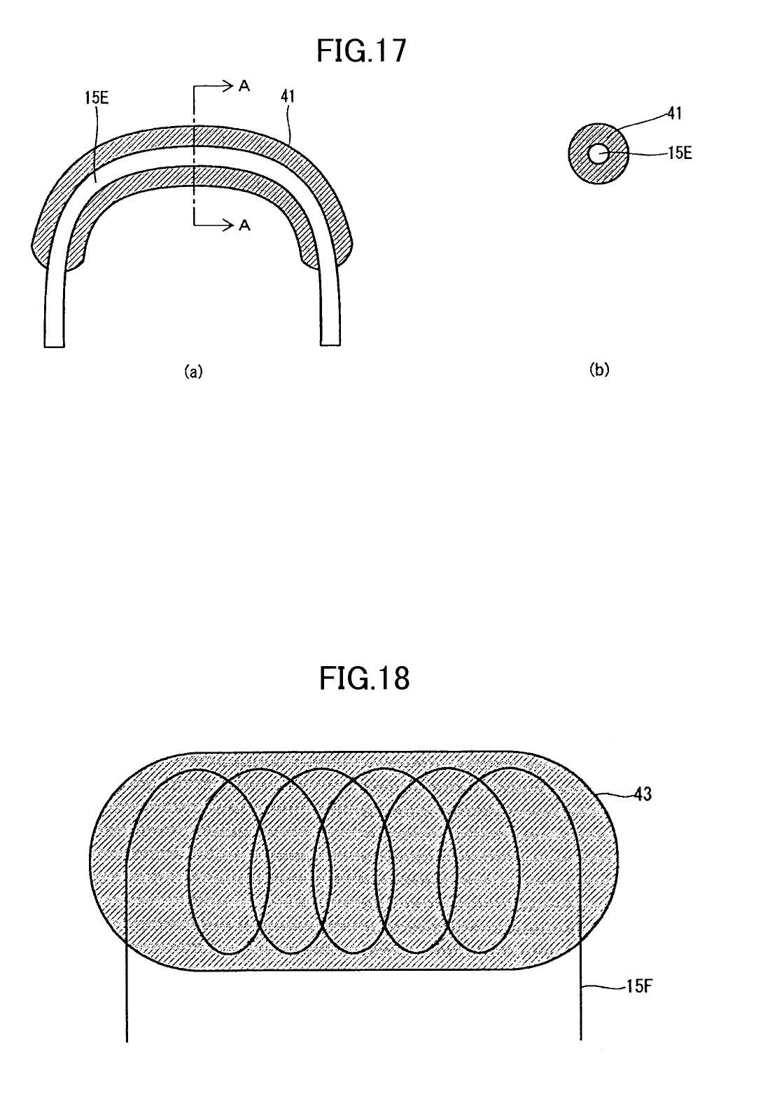

In addition, FIGS. 17(a) and 17(b) illustrate an example in which the wire-shaped electrode 15E is bent in a U-shape that opens towards a discharge space. FIG. 17(b) is a cross sectional view taken along an arrow line A-A in FIG. 17(a). In this example, a mayenite compound 41 coats the U-shaped tip end part of the wire-shaped electrode 15E so that an outer periphery of the tip end part will not be exposed.

Next, a description will be given of a case in which the electrode is a filament formed to a coil shape.

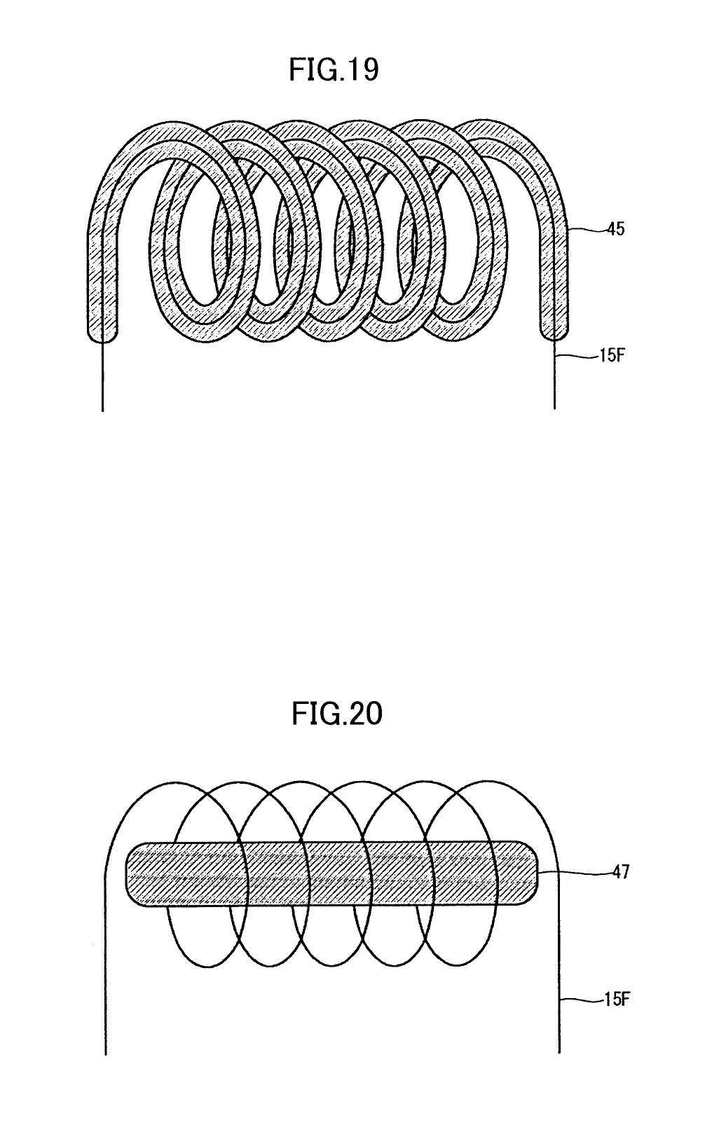

As illustrated in FIG. 18, a mayenite compound 43 may be disposed to cover the entire coil part of a filament 15F. As illustrated in FIG. 19, a mayenite compound 45 may be disposed to cover the wire of the filament 15F. Further, a mayenite compound 47 may be carried inside the coil, as illustrated in FIG. 20.

Next, a description will be given of a case in which the electrode has a strip shape.

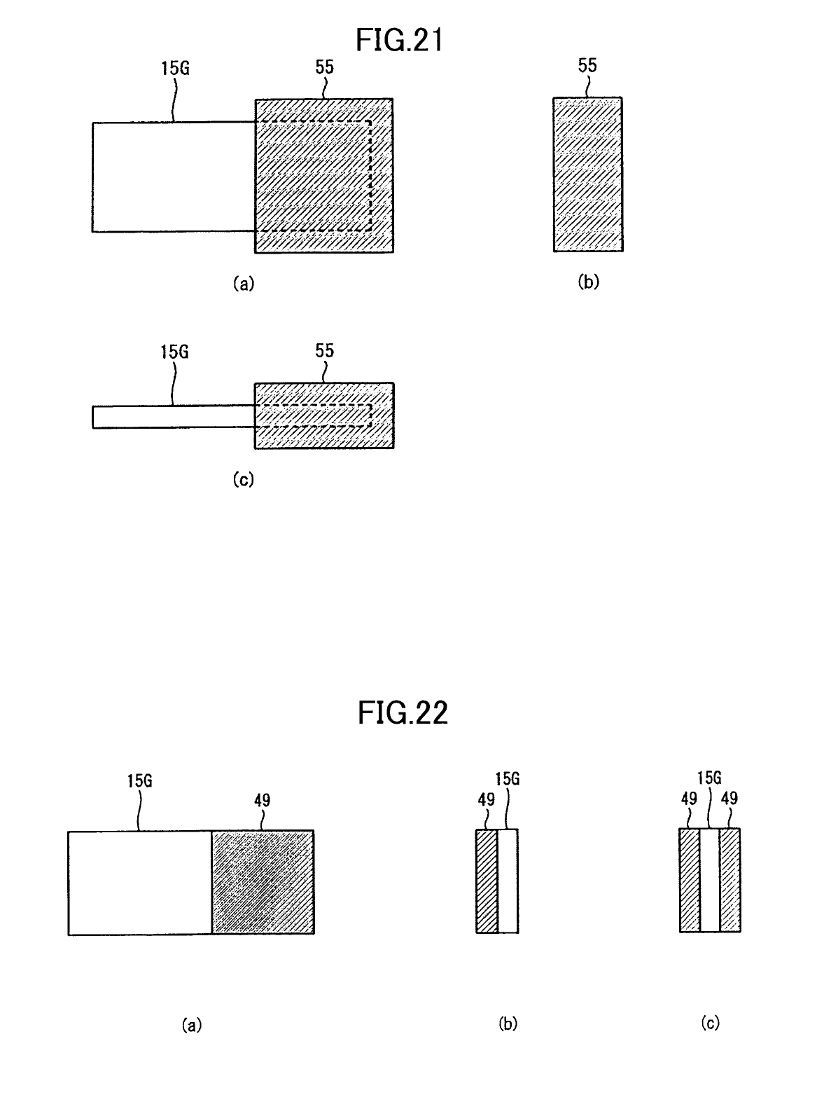

FIG. 21(a) illustrates a plan view, FIG. 21(b) illustrates a side view, and FIG. 21(c) illustrates a bottom view. As illustrated in FIGS. 21(a)-21(c), a mayenite compound 55 may cover a tip end part of a strip-shaped electrode 15G so that a top end periphery and a tip end head part will not be exposed.

FIG. 22(a) illustrates a plan view, and FIGS. 22(b) and 22(c) illustrate side views. FIGS. 22(a)-22(c) illustrate an example in which a mayenite compound 49 is coated on a tip end part of the strip-shaped electrode 15G. The mayenite compound may be coated only on one surface of the electrode as illustrated in FIG. 22(b), and the mayenite compound may be coated on both surfaces of the electrode as illustrated in FIG. 22(c).

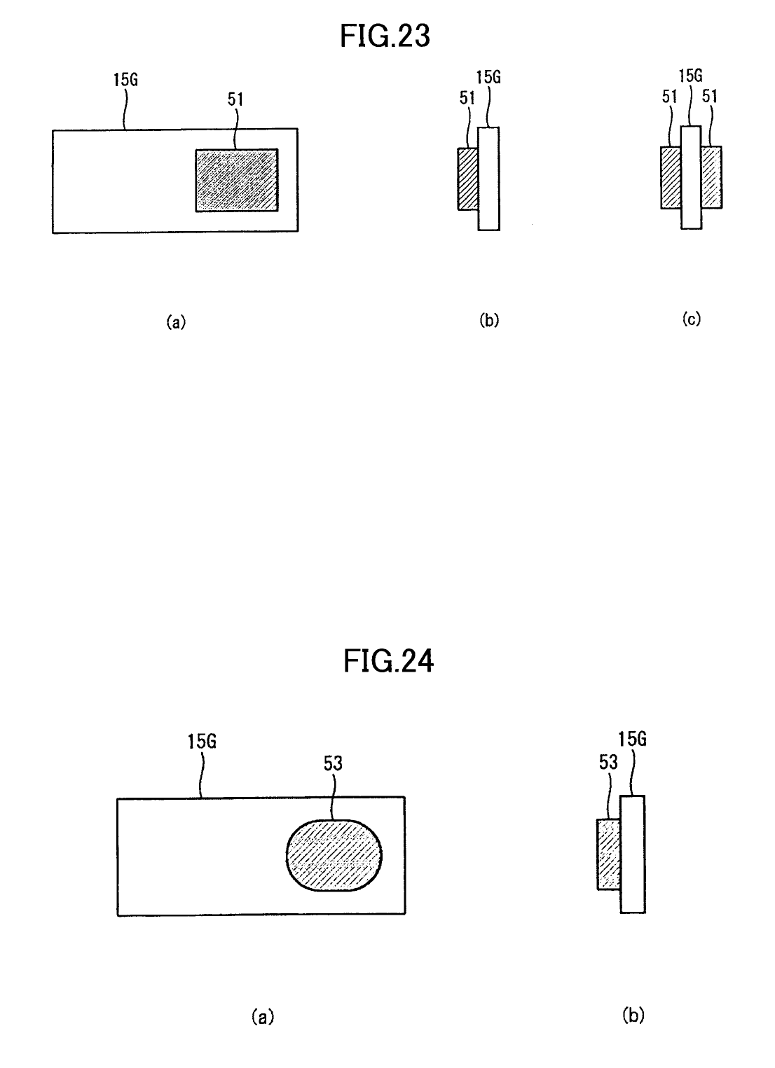

The coverage shape of mayenite compound may be freely selected. As illustrated in FIGS. 23(a)-23(c), a mayenite compound 51 may be partially coated in a rectangular shape with respect to an electrode surface. In addition, as illustrated in FIGS. 24(a) and 24(b), a mayenite compound 53 may be coated in a round shape. FIGS. 23(a) and 24(a) illustrate plan views, and FIGS. 23(b), 23(c) and 24(b) illustrate side views.

In each of the structures described above, the mayenite compound may be sprayed in powder form, coated to a thick film, or filled into the cup or cylinder. The mayenite compound is preferably coated to a thickness of 5 μm to 300 μm. In the case in which the mayenite compound projects, the projecting portion preferably has a length of 30 mm or less.

In the embodiment illustrated in FIG. 1, the mayenite compound 9 that has the surface of the surface layer thereof that has been plasma treated coats the entire periphery on the inner side and partially coats the outer side of the cup-shaped cold cathode. In other words, in the cold cathode fluorescent lamp 20 of this embodiment, the mayenite compound is provided on at least a part of the electrodes 5A and 5B, and the surface of the surface layer of the mayenite compound has been plasma treated.

However, the mayenite compound whose surface of the surface layer thereof has been plasma treated may exist inside the cold cathode fluorescent lamp 20, not only in the electrode, and a reduction in the cathode fall voltage may be expected as long as the mayenite compound is in contact with a discharge gas. For this reason, the mayenite compound may exist at locations in contact with the discharge gas, including the inside of the glass tube 1, the electrode existing inside the glass tube 1, the phosphor 3, and other parts (for example, a metal or the like arranged in a vicinity of the electrode).

In addition, the plasma that treats the surface of the surface layer of the mayenite compound may be the plasma generated by the discharge at the time when the cold cathode fluorescent lamp is used. For this reason, the surface of the surface layer of the mayenite compound existing inside the cold cathode fluorescent lamp may not be plasma treated in advance, and in this case, the mayenite compound exhibits preferable effects after use under predetermined discharge conditions.

Therefore, in the present invention, the mayenite compound is provided in at least a part of the discharge lamp electrode, and the surface of the surface layer of the mayenite compound is plasma treated in order to realize the electrode for the discharge lamp that may reduce the cathode fall voltage.

As described above, the electrode for the discharge lamp in the present invention may be the cold cathode having the plasma treated surface of the surface layer of the mayenite compound in at least a part of the electrode including a metal base such as nickel, molybdenum, tungsten, and niobium. Examples of the shape of the electrode including the metal base may include the cup shape, strip shape, tubular shape, rod shape, wire shape, coil shape, hollow shape, and the like. Examples of the metal base include nickel, molybdenum, tungsten, niobium, and alloys of such metals, including kovar, but the metal base is not limited to such metals. Particularly, nickel and kovar are preferable for use as the metal base because such materials are easily available and are inexpensive.

FIG. 3(a)-FIG. 24(b) illustrate examples of the embodiments in which the mayenite compound covers the cold cathode. However, the present invention is not limited to the embodiment in which the mayenite compound covers the electrode including the metal base. In other words, at least a part of the electrode may be formed solely by the mayenite compound, and a bulk of a sintered body of the mayenite compound, or the like, may form the electrode for the discharge lamp. In this case, the surface at the layer surface of the bulk may be formed to the desired shape of the electrode for the discharge lamp and plasma treated.

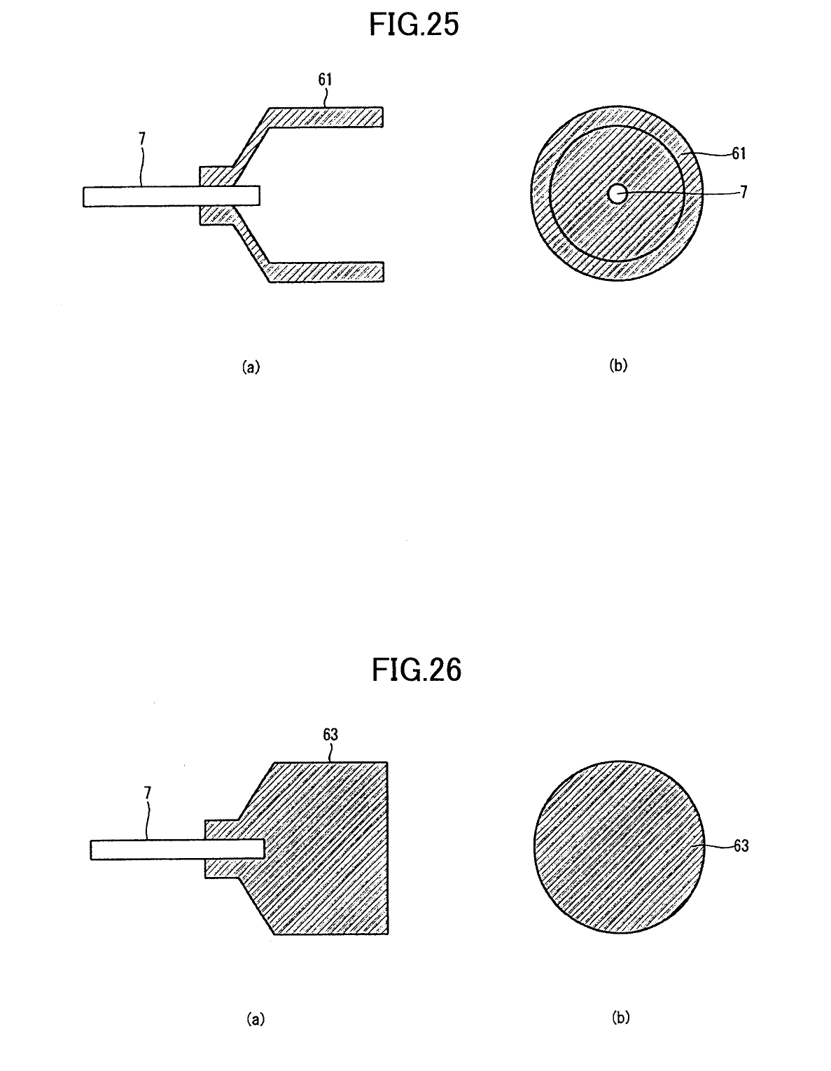

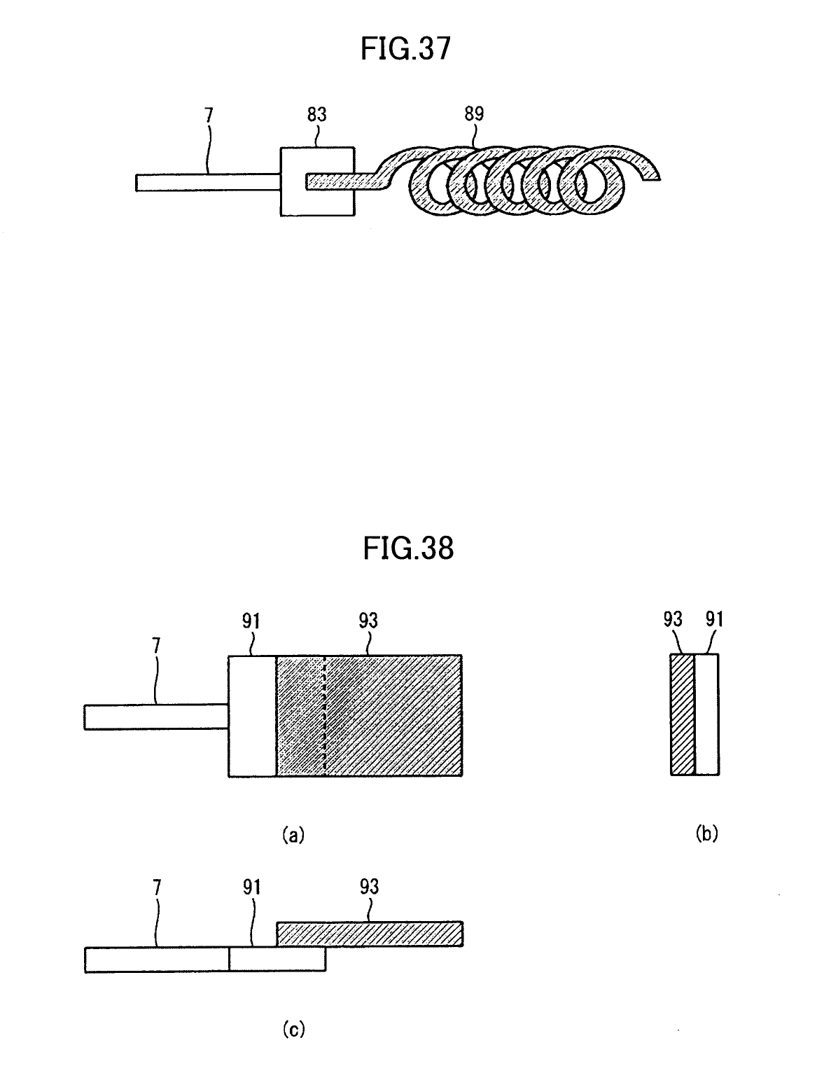

Examples of the electrodes formed solely by the sintered body of the mayenite compound are illustrated in FIG. 25(a)-FIG. 40(c). In FIG. 25(a)-FIG. 35(b), (a) illustrates a front cross sectional view, and (b) illustrates a side view. In addition, FIGS. 36 and 37 illustrate plan views. In FIG. 38(a)-FIG. 40(b), (a) illustrates a front cross sectional view, (b) illustrates a side view, and (c) illustrates a bottom view.

FIGS. 25(a) and 25(b) illustrate an example in which the cup-shaped electrode is formed by a sintered body 61 of the mayenite compound. However, as illustrated in FIGS. 26(a) and 26(b), the inside of the cup may be filled by a sintered body 63 of the mayenite compound.

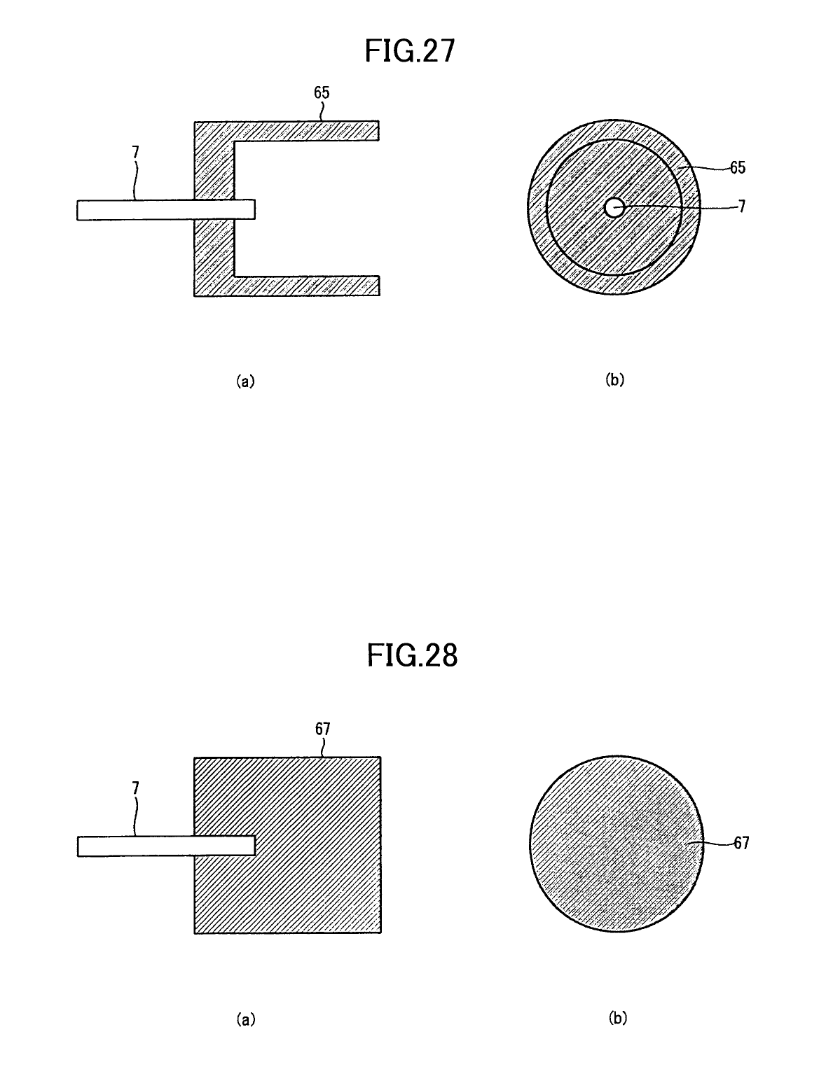

FIGS. 27(a) and 27(b) illustrate an example in which the electrode is formed to a tubular shape from a sintered body 65 of the mayenite compound. FIGS. 28(a) and 28(b) illustrate an example in which the electrode is formed to a cylindrical column shape from a sintered body 67 of the mayenite compound.

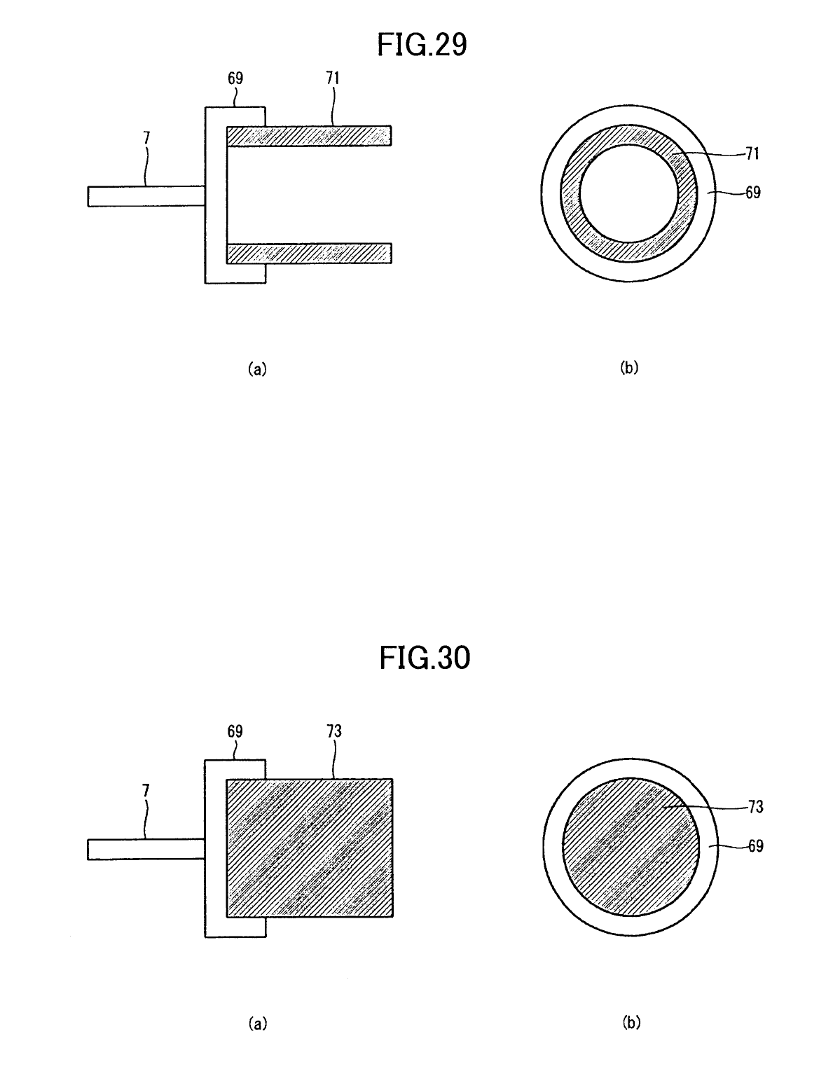

FIG. 29(a)-FIG. 34(b) illustrate examples in which the electrode formed by the sintered body of the mayenite compound is provided via a fixing metal 69 having a flange projecting from a disk-shaped bottom surface thereof.

A sintered body 71 of the mayenite compound illustrated in FIGS. 29(a) and 29(b) has a cylindrical shape. A sintered body 73 of the mayenite compound illustrated in FIGS. 30(a) and 30(b) has a cylindrical column shape.

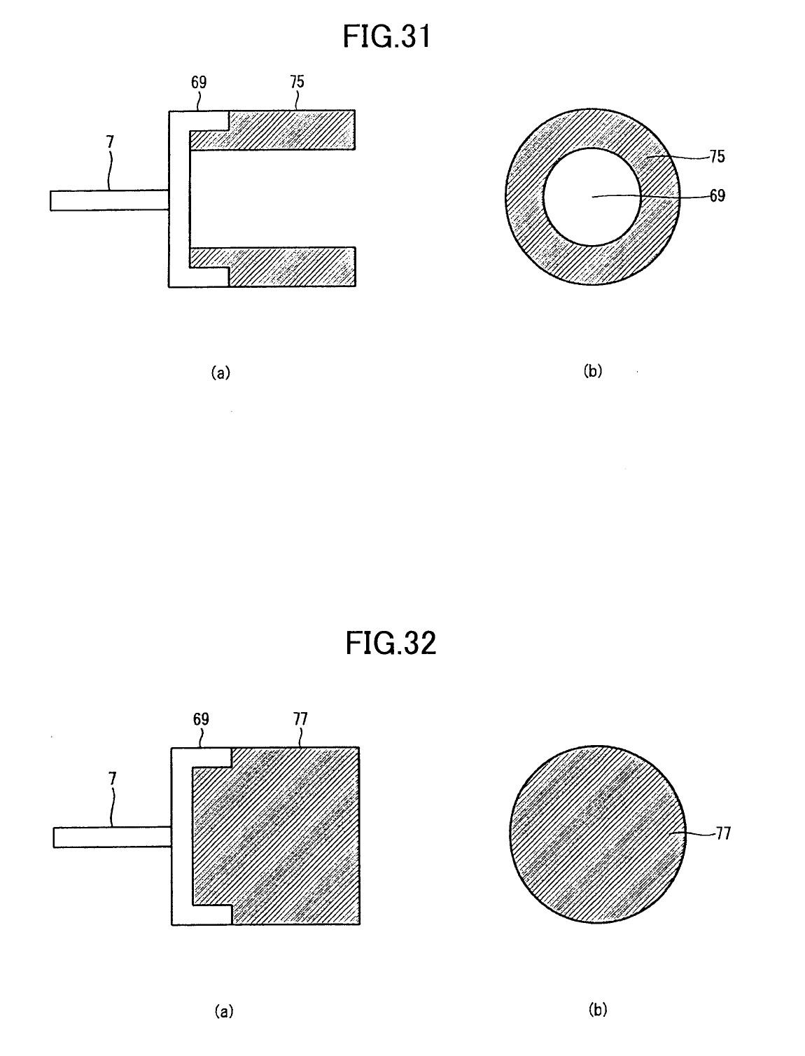

In addition, a sintered body 75 of the mayenite compound illustrated in FIGS. 31(a) and 31(b) and a sintered body 77 of the mayenite compound illustrated in FIGS. 32(a) and 32(b) cover an upper end surface of the flange of the fixing metal 69 and are aligned to an outer periphery of the flange.

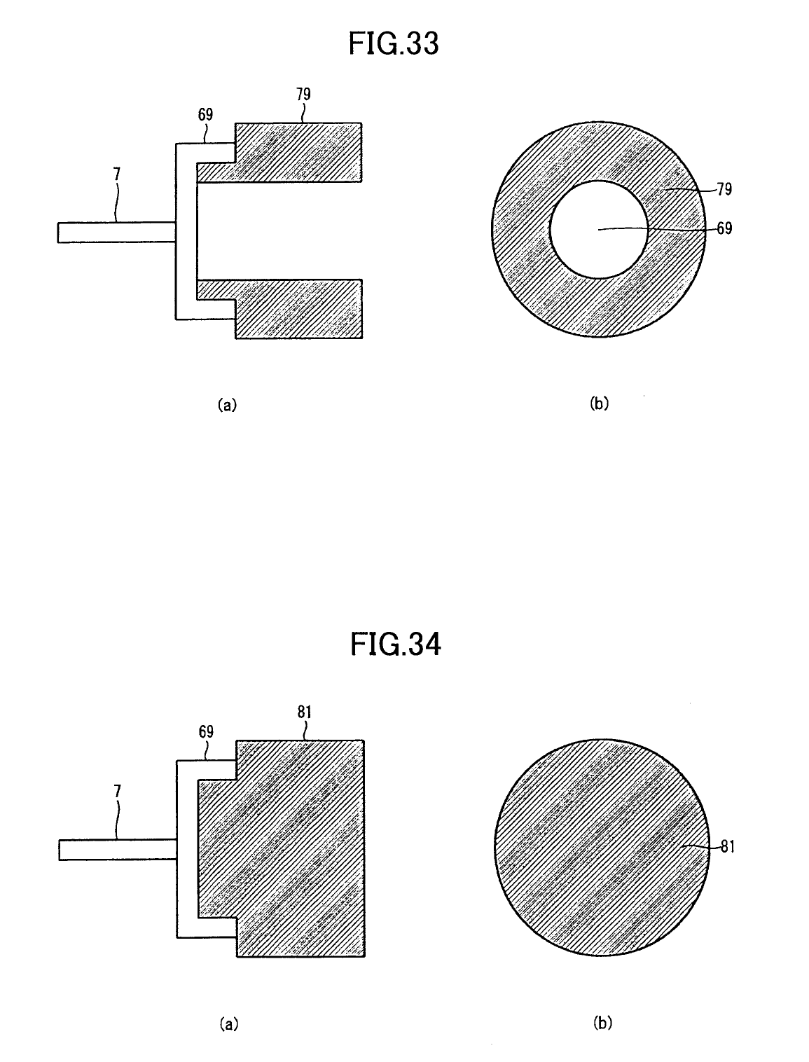

Further, a sintered body 79 of the mayenite compound illustrated in FIGS. 33(a) and 33(b) and a sintered body 81 of the mayenite compound illustrated in FIGS. 34(a) and 34(b) cover the upper end surface of the flange of the fixing metal 69 and project from the outer periphery of the flange.

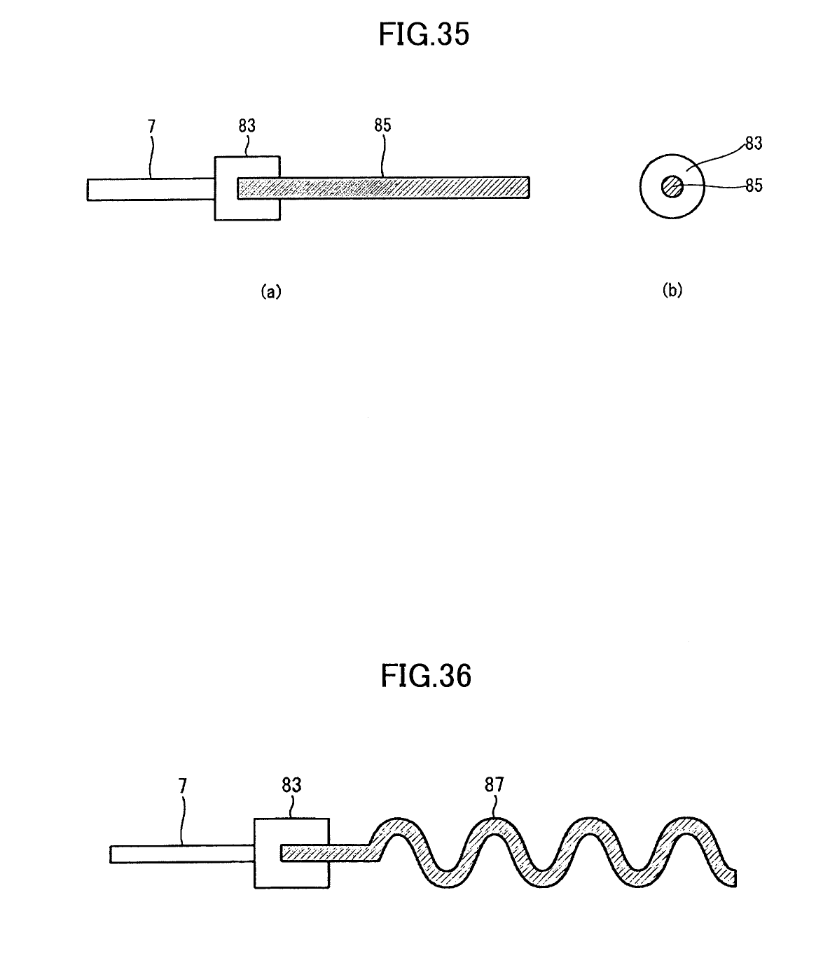

FIG. 35(a)-FIG. 37 illustrate examples in which the wire-shaped electrode is formed solely by the sintered body of the mayenite compound.

The wire-shaped electrode is mounted via a fixing metal 83. The wire-shaped electrode may form a linear electrode 85 illustrated in FIGS. 35(a) and 35(b) or, may form a wave-shaped electrode 87 illustrated in FIG. 36 or, may form a spiral electrode 89 illustrated in FIG. 37.

Next, examples in which the sintered body of the mayenite compound is provided with respect to an electrode including a plate-shaped fixing bracket are illustrated.

FIG. 38(a) illustrates a plan view, FIG. 38(b) illustrates a side view, and FIG. 38(c) illustrates a bottom view. A sintered body 93 of the mayenite compound, that is formed to a rectangular shape to match a width of the electrode, may be fixed on a top surface of an electrode 91 including the plate-shaped fixing bracket, as illustrated in FIGS. 38(a)-38(c).

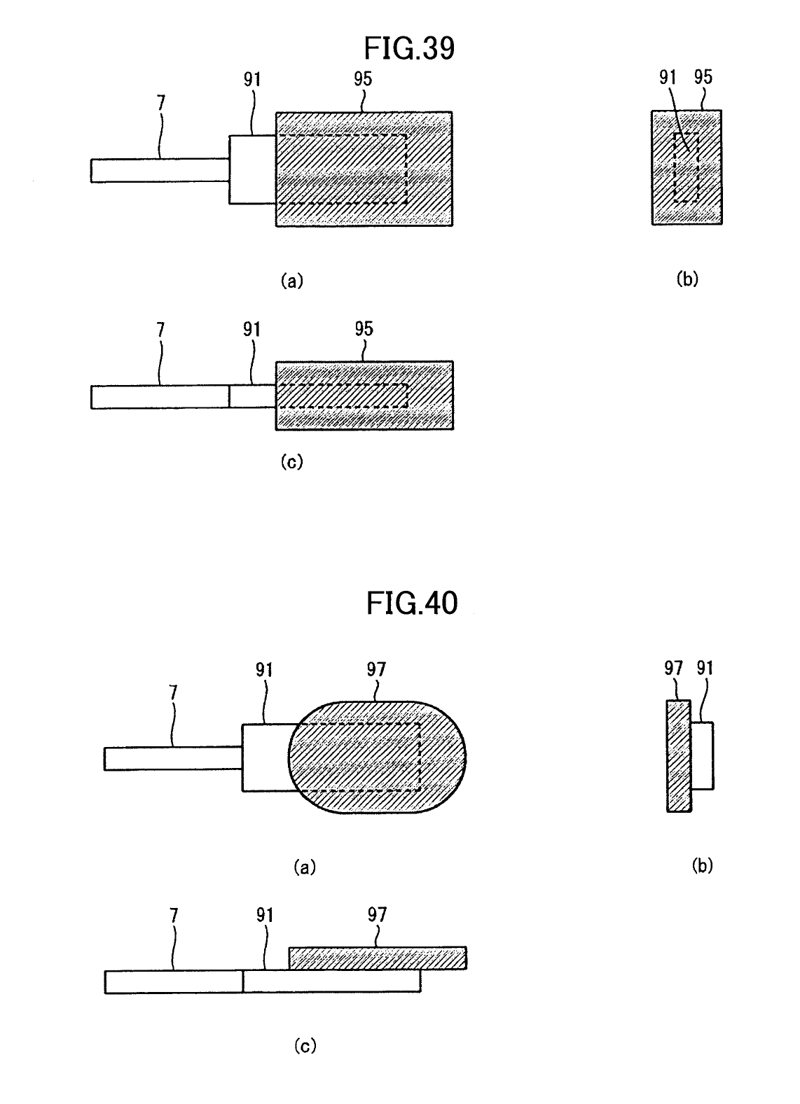

In addition, a sintered body 95 of the mayenite compound may be formed to receive a tip end part of the electrode 91 including the plate-shaped fixing bracket, fitted into the sintered body 95, as illustrated in FIGS. 39(a)-39(c).

Further, a sintered body 97 of the mayenite compound, that is formed to an oval plate shape exceeding the width of the electrode, may be fixed on the top surface of the electrode 91 including the plate-shaped fixing bracket, as illustrated in FIGS. 40(a)-40(c).

Moreover, the dimensions of the electrode formed from the sintered body may be changed appropriately depending on the configuration of the lamp, however, a length of the electrode is preferably 2 mm to 50 mm. When the manufacturing ease of the sintered body is taken into consideration, the diameter of wire-shaped electrode is preferably 0.1 mm to 3 mm, the width of the plate-shaped electrode is preferably 1 mm to 20 mm and the thickness of the plate-shaped electrode is preferably 0.1 mm to 3 mm, and the outer diameter of the cup-shaped or cylindrical or cylindrical column shaped electrode is preferably 1 mm to 20 mm, and the thickness of the cup-shaped or cylindrical electrode is preferably 0.1 mm to 5 mm.

The plasma treatment may subject the surface at the layer surface of the sintered body of the mayenite compound, covering or coating the electrode or, forming at least a part of the electrode, to the plasma.

The plasma is preferably generated from a gas having a pressure of 0.1 Pa to 10000 Pa and selected from a noble gas, hydrogen, and a mixed gas of the noble gas and hydrogen, and further including mercury gas in the selected one of the noble gas, hydrogen gas, and the mixed gas. These gases may further include an inert gas. By subjecting the mayenite compound to such plasma, the performance of the secondary electron emission from the surface layer may be improved considerably.

The plasma treatment may generate the plasma from the gas sealed within a chamber or, spray the plasma generated by a plasma generating apparatus on the surface of the mayenite compound. The time for which the mayenite compound is subjected to the plasma may depend on the kind of mayenite compound, and may be approximately 5 hours or less.

The method of generating the plasma is not limited to a particular method, but it is particularly preferable to prepare an opposing electrode and apply an alternating voltage (AC voltage) across the electrodes. This is because the mayenite compound is essentially an insulator when the electron density of the mayenite compound is low, and the plasma is easy to maintain when the mayenite compound is arranged. A power of the AC voltage that is applied is preferably 0.1 W to 1000 W.

A frequency of the AC voltage is not limited to a particular frequency, and may be 100 Hz to 50 GHz, for example. The frequency of the AC voltage may be in a RF (Radio Frequency) range, a VHF (Very High Frequency) range, and a microwave frequency range, for example. Normally, the frequencies used for these ranges are 13.56 MHz, on the order of 40 MHz to 120 MHz, and 2.45 GHz. Amongst these frequencies, 13.56 MHz is further preferable from the point of view of the ease with which the plasma generating apparatus using 13.56 MHz may be acquired.

Examples of preferable plasma treatment methods may include the following. The cold cathode fluorescent lamp, which is one type of discharge lamp, is filled with a mixed gas of the noble gas and mercury gas at a pressure on the order of 1000 Pa to 10000 Pa, and plasma of the mixed gas is generated and discharged by applying the AC voltage of several tens of kHz when turning on the cold cathode fluorescent lamp as a product. For this reason, the plasma treatment may be performed by the plasma generated by the AC discharge within the cold cathode fluorescent lamp when the cold cathode fluorescent lamp is turned on as a product or, during the discharge lamp manufacturing process. The former case in which the plasma treatment is performed when the cold cathode fluorescent lamp is turned on as the product is further preferable in that a special plasma treatment process may be omitted when manufacturing the cold cathode and the cold cathode fluorescent lamp.

With regard to the effects on the material caused by the plasma, virtually no change has been observed for the appearance by a surface observation made by an optical microscope and an electron microscope. However, it may be inferred that the effects occur in a range of approximately 100 μm from the surface, due to collision of charged particles of the plasma with the mayenite compound and moving of the charge associated therewith.

After the surface of the surface layer is plasma treated, the treated surface is preferably not exposed to an atmospheric ambient. This is because the plasma treated surface, when exposed to oxygen and water vapor within the atmospheric ambient, may change the surface state thereof and deteriorate the performance of the secondary electron emission. Accordingly, it is desirable to manufacture the product in a state in which the plasma treated surface is not exposed to the atmospheric ambient.

The electrode provided with the mayenite compound 9 having the surface of the surface layer thereof plasma treated in advance, may be mounted within the glass tube 1 without being exposed to the atmosphere. In addition, the atmosphere may be replaced by the discharge gas in a state in which the mayenite compound 9 is arranged inside the glass tube 1 in advance. In this case, the discharge gas may be sealed after the plasma treatment without exposing the plasma treated surface to the atmosphere. Alternatively, an AC voltage may be applied across the electrodes after the discharge gas is sealed, in order to generate the plasma that subjects the surface of the surface layer of the mayenite compound to the plasma treatment.

Next, a description will be given of the mayenite compound.

In the present invention, the mayenite compound may be 12CaO—7Al₂O₃ (hereinafter referred to as “C12A7”) formed from calcium (Ca), aluminum (Al) and oxygen (O) and having a cage structure, 12SrO—7Al₂O₃ compound having the calcium of the C12A7 substituted by strontium (Sr), mixed crystal compound of those, and isomorphic compounds having a crystal structure equivalent to those. The mayenite compounds described above have a high resistance to sputtering with respect to ions of the mixed gas described above used in the discharge lamp, and are preferable in that the life of the electrode for the discharge lamp may be lengthened.

The mayenite compounds described above clathrate oxygen ions within respective cages, and at least a part of the cations or anions within the framework or cage may be substituted within a range in which the framework of the crystal lattice of C12A7 and the cage structure formed by the framework may be maintained. The oxygen ions clathrated within the cage are hereinafter referred to as free oxygen ions as it is customary to do so. For example, in C12A7, a part of Ca may be substituted by atoms of magnesium (Mg), strontium (Sr), barium (Ba), lithium (Li), sodium (Na), copper (Cu), chromium (Cr), manganese (Mn), cerium (Ce), cobalt (Co), nickel (Ni), and the like. In C12A7, a part of Al may be substituted by atoms of silicon (Si), germanium (Ge), boron (B), gallium (Ga), titanium (Ti), manganese (Mn), iron (Fe), cerium (Ce), praseodymium (Pr), terbium (Tb), scandium (Sc), lanthanum (La), yttrium (Y), europium (Eu), ytterbium (Yb), cobalt (Co), nickel (Ni), and the like. Further, oxygen in the cage or framework may be substituted by nitrogen (N) and the like. Of course, the elements that are substituted may not be limited to the elements described above.

In the present invention, at least a part of the free oxygen ions in the mayenite compound may be substituted by electrons. In this specification, a mayenite compound having an electron density of 1.0×10¹⁵ cm⁻³ or higher may be referred to as a conductive mayenite compound. However, because a heat treatment under a reduction atmosphere, which will be described later, is required for the electron substitution, the electron density is preferably lower than 1.0×10¹⁷ cm⁻³ from the point of view of minimizing the load at the time of the manufacture. A theoretical upper limit of the electron density is 2.3×10²¹ cm⁻³.

The following compounds (1)-(4) are particular examples of the mayenite compound, but the mayenite compound is of course not limited to such examples.

(1) Calcium magnesium aluminate (Ca_{1-y}Mg_{y})₁₂Al₁₄O₃₃ or calcium strontium aluminate (Ca_{1-z}Sr_{z})₁₂Al₁₄O₃₃, which are mixed crystals in which a part of Ca in the framework of the C12A7 compound is substituted by magnesium or strontium, where y and z are preferably 0.1 or less.

(2) Ca₁₂Al₁₀Si₄O₃₅ which is silicon substitution type mayenite.

(3) For example, Ca₁₂Al₁₄O₃₂:2OH⁻ or Ca₁₂Al₁₄O₃₂:2F⁻, in which the free oxygen ions within the cage are substituted by anions such as H⁻, H²⁻, O⁻, O²⁻, OH⁻, Cl⁻, Br⁻, S²⁻, and Au⁻.

(4) For example, wadalite Ca₁₂Al₁₀Si₄O₃₂:6Cl⁻ in which both the cations and anions are substituted.

In the mayenite compounds described above, at least a part of the free oxygen ions forming the mayenite compound may preferably be substituted by anions of atoms having an electron affinity smaller than that of the free oxygen ions. Examples of the anions may include F⁻, Cl⁻ and Br⁻ that are halogen ions, H₂⁻ and H²⁻ that are anions of the hydrogen atom or hydrogen molecule, O⁻ and O₂⁻ that are reactive oxygen species, OH⁻ that is a hydroxide ion, and the like. H⁻ is particularly preferable as the anion. The time for which the mayenite compound is subjected to the plasma may be reduced when the free oxygen ions are substituted by H⁻ ions.

The density of the H⁻ ions substituting the free oxygen ions within the mayenite compound is preferably 1.0×10¹⁵ cm⁻³ or higher, and more preferably 1.0×10¹⁹ cm⁻³ or higher, and further more preferably 1.0×10²⁰ cm⁻³ or higher. This is because the performance of the secondary electron emission after the plasma treatment becomes higher when the density of H⁻ ions is higher, to thereby further reduce the cathode fall voltage.

A theoretical upper limit of the H⁻ ion density is 2.3×10²¹ cm⁻³. The time for which the mayenite compound is subjected to the plasma for a case in which the H⁻ ion density of the mayenite compound is 1.0×10¹⁵ cm⁻³ or higher is preferably 0.01 second to 10 minutes, and more preferably 0.1 second to 5 minutes, and further more preferably 1 second to 1 minute. When the time for which the mayenite compound is subjected to the plasma is shorter than 0.01 second, the performance of the secondary electron emission may not improve.

In a case in which the H⁻ ion density of the mayenite compound is lower than 1.0×10¹⁵ cm⁻³, the time for which the mayenite compound is subjected to the plasma differs depending on the electron density. The time for which the mayenite compound is subjected to the plasma when the electron density is 1.0×10¹⁷ cm⁻³ is preferably 0.01 second to 10 minutes, and more preferably 0.1 second to 5 minutes, and further more preferably 1 second to 1 minute. When the time for which the mayenite compound is subjected to the plasma is shorter than 0.01 second, the performance of the secondary electron emission may not improve.

In a case in which the electron density of the mayenite compound is 1.0×10¹⁵ cm⁻³ or higher and is less than 1.0×10¹⁷ cm⁻³, the time for which the mayenite compound is subjected to the plasma is preferably 0.1 second to 30 minutes, and more preferably 0.5 second to 20 minutes, and further more preferably 1 second to 10 minutes. Under such conditions, there is notable improvement in the performance of the secondary electron emission before and after the plasma treatment, when compared to the case in which the electron density is as described above. The performance of the secondary electron emission may not improve when the time for which the mayenite compound is subjected to the plasma is shorter than 0.1 second.

In a case in which the electron density of the mayenite compound is less than 1.0×10¹⁵ cm⁻³, the time for which the mayenite compound is subjected to the plasma is preferably 10 minutes to 5 hours, and more preferably 30 minutes to 4 hours, and further more preferably 1 hour to 3 hours. The performance of the secondary electron emission may not improve when the time for which the mayenite compound is subjected to the plasma is shorter than 10 minutes.

In a case in which at least a part of the electrode is formed by the sintered body of the mayenite compound, it is preferable that at least a part of the free oxygen ions in the mayenite compound is substituted by electrons, and the electron density is 1×10¹⁹ cm⁻³ or higher. It is not preferable that the electron density is less than 1×10¹⁹ cm⁻³, because the conductivity decreases, a potential distribution is generated when the voltage is applied to the electrodes, and the electrode may not function as the electrode for the discharge lamp. The electron density is more preferably 5×10¹⁹ cm⁻³ or higher, and further more preferably 1×10²⁰ cm⁻³ or higher.

In this specification, the electron density of the conductive mayenite refers to a measured value of the spin density that is measured using an electron spin resonance apparatus or, calculated based on a measurement of an absorption coefficient. Generally, the electron density may preferably be measured using the electron spin resonance apparatus (ESR apparatus) when the measured value of the spin density is lower than 10¹⁹ cm⁻³, and the electron density may be calculated in the following manner when the spin density exceeds 10¹⁶ cm⁻³. First, a spectrophotometer is used to measure an intensity of light absorption by the electrons inside a cage of the conductive mayenite, and the absorption coefficient at 2.8 eV is obtained. Next, the electron density of the conductive mayenite is quantified using that the obtained absorption coefficient is in proportion to the electron density. In addition, if the conductive mayenite compound is powder or the like and it is difficult to carry out the measurement of a transmission spectrum by a photometer, a diffuse reflectance spectrum is measured using an integrating sphere, and the electron density of the conductive mayenite is calculated from the value acquired according to the Kubelka-Munk method.

In addition, in this specification, the density of the H⁻ ions substituting the free oxygen ions within the mayenite compound may be calculated by irradiating ultraviolet ray of 330 nm for 30 minutes, and causing a reaction H⁻→H⁰+e⁻ to sufficiently progress, before measuring the amount of electrodes desorbed from the H⁻ ions by the method described above.

The crystal structure of the mayenite compound is more preferably polycrystalline than monocrystalline. In addition, the polycrystalline powder of the mayenite compound may be sintered. When the mayenite compound is monocrystalline, the performance of the secondary electron emission may deteriorate unless a suitable crystal face is exposed at the surface.

In addition, the manufacturing process becomes complex when it is necessary to expose a specific crystal face. The polycrystalline structure is preferable because a decrease in the work function and an improved performance of the secondary electron emission may be expected by the existence of a grain boundary. Further, the electrons scattered at the grain boundary further generate thermoelectrons, field emission electrons, and secondary emission electrons, and the effect of improving the performance of the electron emission may be expected.

The mayenite compound carried by the electrode may include, within the same grain or bulk, a compound other than the mayenite compound described above. Examples of the compound other than the mayenite compound include calcium aluminate such as CaO—Al₂O₃ and 3Ca—Al₂O₃, calcium oxide CaO, and aluminum oxide Al₂O₃, and the like. However, in order to efficiently emit the secondary electrons from the surface of the electrode for the discharge lamp, it is more preferable that the mayenite compound existing within the same grain or bulk is 50 volume % or greater.

Next, a description will be given of the method of manufacturing the electrode for the discharge lamp, having a low cathode fall voltage. One aspect of the present invention provides a manufacturing method characterized in that a part of or the entire electrode is formed by the mayenite compound, and the surface of the surface layer of the mayenite compound of the electrode is subjected to the plasma treatment in order to facilitate the secondary electron emission.

In the following description, a process in which a part of or the entire electrode is formed by the mayenite compound will be referred to as “an electrode forming process”, and a process in which the surface layer of the mayenite compound of the electrode is plasma treated in order to facilitate the secondary electron emission will be referred to as “a plasma treatment process”. Although the manufacturing method of the present invention is described by way of an example, the present invention is of course not limited to the example.

[Electrode Forming Process]

In the case in which the electrode for the discharge lamp includes the metal base and the mayenite compound is provided on at least a part of the metal base, the mayenite compound may cover the metal base of the electrode.

Examples of the method of covering the mayenite compound may include a method that carries out a normally used wet process in order to mix the mayenite compound in the powder form to a solvent, a binder, and the like, before coating the mayenite compound to a desired part using spray coating, spin coating, dip coating, or screen printing, and a method that deposits the mayenite compound on at least a part of the electrode for the discharge lamp using a physical vapor deposition method such as a vacuum vapor deposition, an electron beam vapor deposition, a sputtering, a thermal spray, etc.

More particularly, a slurry including the solvent and the binder is adjusted and coated on the surface of the electrode for the discharge lamp by dip coating or the like. A heat treatment is carried out at 50° C. to 200° C. and maintained for 30 minutes to 1 hour in order to remove the solvent, and a heat treatment is carried out at 200° C. to 800° C. and maintained for 20 minutes to 30 minutes in order to remove the binder.

The mayenite compound powder used in the above described method may be manufactured by grinding, for example. The grinding preferably performs a coarse grinding before performing a fine grinding. The coarse grinding may grind the mayenite compound or a material including the mayenite compound into particle sizes on the order of 20 μm in average particle diameter, using a stamp mill, an automatic mortar grinder, or the like. The fine grinding may grind the mayenite compound or the material including the mayenite compound into particle sizes on the over of 5 μm in average particle diameter, using a ball mill, a bead mill, or the like. The grinding may be performed in an atmospheric ambient or, within an inert gas.

In addition, the grinding may be performed within a solvent including no moisture. Examples of a preferable solvent may include an alcohol-based solvent and an ether-based solvent respectively having 3 or more carbon atoms. The grinding is facilitated by the use of such solvents, and thus, the grinding may use one of such solvents or a mixture of such solvents.

When the solvent used for the grinding is a compound having a hydroxyl group with 1 or 2 carbon atoms, such as alcohols and ether, the mayenite compound may react with the compound solvent and become decomposed, which is not preferable. Hence, when the solvent is used at the time of the grinding, the solvent may be volatile by heating to 50° C. to 200° C. in order to obtain the powder.

After the mayenite compound is coated on the electrode including the metal base using the method described above, it may be preferable to carry out a heat treatment at 600° C. to 1415° C. for a holding time on the order of 30 minutes to 2 hours in an environment in which the metal part of the electrode will not be oxidized, including an inert gas atmosphere such as a nitrogen gas, a vacuum atmosphere, and a reducing atmosphere, in order to strongly bond the mayenite compound on the metal base of the electrode.

The reducing atmosphere means an atmosphere or a depressurized environment in which a reducing agent exists in a portion contacting the atmosphere and an oxygen partial pressure is 10⁻³ Pa or lower. For example, carbon or aluminum powder may be mixed as the reducing agent to the mayenite compound, and the reducing agent may be mixed to a source material (for example, calcium carbonate and aluminum oxide) of the mayenite compound when the mayenite compound is made. In addition, carbon, calcium, aluminum, and titanium may be provided at the part in contact with the atmosphere. In the case of carbon, for example, the electrode may be set in a carbon container and fired under vacuum. By carrying out a heat treatment under the reducing atmosphere, at least a part of the free oxygen ions within the mayenite compound may be substituted by the electrons.

Furthermore, in the case in which the heat treatment temperature is 1200° C. to 1415° C., which is the temperature at which the mayenite compound is synthesized, and C12A7 is used as the mayenite compound, for example, a calcium compound and an aluminum compound may be mixed and adjusted to a mole fraction of 12:7 in an oxide scale, and thereafter mixed in an equipment such as a ball mill. The resulting mixture may be mixed with a solvent, a binder, and the like in order to obtain a slurry or a paste to be coated. According to this method, the manufacturing of the mayenite compound and the manufacturing of the sintered body of the mayenite compound powder may be achieved simultaneously.

In the heat treatment that fuses the mayenite compound and the electrode including the metal base, it may be preferable to carry out the heat treatment at 600° C. to 1415° C. for a holding time on the order of 30 minutes to 2 hours in a hydrogen atmosphere. This heat treatment is more preferable in that at least a part of the free oxygen ions within the mayenite compound is substituted by H⁻ ions, thus making it possible to shorten the time for which the mayenite compound is to be subjected to the plasma during the plasma treatment. When the electron density of the mayenite compound is 1×10¹⁵ cm⁻³ or higher when this heat treatment is carried out, the electrons substituting the free oxygen are more easily substituted by H⁻ ions, and it is further more preferable in that the H⁻ ion density may more easily be made high.

The atmosphere in which the heat treatment is carried out may be a mixed atmosphere in which an inert gas such as nitrogen and argon is mixed to hydrogen, as long as hydrogen is included in the atmosphere. The volume % of hydrogen in the mixed atmosphere may preferably be 1 volume % or higher, and more preferably be 10 volume % or higher, and further more preferably be 30 volume % or higher. When the volume % of hydrogen within the mixed atmosphere is lower than 1 volume %, it is not preferable in that the H⁻ ion density may not become 1×10¹⁵ cm⁻³ or higher.

In addition, in the case in which the heat treatment temperature is 1200° C. to 1415° C., which is the temperature at which the mayenite compound is synthesized, the source material of the mayenite compound, such as the calcium compound and the aluminum compound, may be coated. Moreover, in order to realize an electrode having an even higher H⁻ ion density, it may be particularly preferable to grind and coat the mayenite compound in which at least a part of the free oxygen ions is substituted by the H⁻ ions or, the conductive mayenite compound in which at least a part of the free oxygen ions is substituted by the electrons, on the electrode of the metal base, and thereafter carry out the heat treatment in the hydrogen atmosphere.

Next, a description will be given of a case in which at least a part of the electrode is foamed by the sintered body of the mayenite compound. When forming a part of the electrode by the sintered body of the mayenite compound, at least a part of the free oxygen ions of the mayenite compound needs to be substituted by the electrons, and the density of the electrons needs to be 1×10¹⁹ cm⁻³ or higher.

For this reason, the sintered body is preferably manufactured by forming the slurry or paste of the mayenite compound powder in advance so that it becomes a desired shape, such as the electrode or a part thereof, after the sintering, and firing the shaped slurry or paste under the condition that at least a part of the free oxygen ions is substituted by the electrons. The sintered body may be subjected to a process after the firing if necessary.

The sintering of the mayenite compound powder is preferably carried out by forming the powder or the slurry or paste formed from the powder into a desired shape by press molding, injection molding, extrusion molding, or the like, and firing a molded body after the molding under the condition in which at least a part of the free oxygen ions is substituted by the electrons.

The powder may be formed into the paste or slurry by mixing thereto a binder such as polyvinyl alcohol or, by supplying only the powder into a pressing machine and applying pressure to thereby fault a green compact. However, the shape of the molded body needs to take into consideration a shrinkage of the shape caused by the firing.

For example, polyvinyl alcohol may be mixed, as the binder, to the mayenite compound powder having an average particle diameter of 5 μm and pressed using a desired die in order to obtain the molded body. When forming the molded body using the paste or slurry including the binder, it is preferable to remove the binder by maintaining 200° C. to 800° C. for 20 minutes to 30 minutes before firing the molded body.

The atmosphere in which the molded body is fired needs to be the reducing atmosphere described above in order to substitute at least a part of the free oxygen ions by the electrons.

The oxygen partial pressure is preferably 10⁻³ Pa, and more preferably 10⁻⁵ Pa, and further more preferably 10⁻¹⁰ Pa, and particularly more preferably 10⁻¹⁵ Pa. When the oxygen partial pressure is higher than 10⁻³ Pa, it is not preferable in that a sufficient conductivity may not be obtained. The heat treatment temperature is preferably 1200° C. to 1415° C., and more preferably 1250° C. to 1350° C. When the heat treatment temperature is lower than 1200° C., the sintering does not progress and it is not preferable in that the sintered body becomes fragile.

In addition, when the heat treatment temperature is higher than 1415° C., melting progresses and it is not preferable in that the shape of the molded body may not be maintained. The time for which the heat treatment temperature described above is to be maintained may be adjusted so that the sintering of the molded body may be completed. The time for which the heat treatment temperature is to be maintained is preferably 5 minutes to 6 hours, and more preferably 30 minutes to 4 hours, and further more preferably 1 hour to 3 hours. When the time for which the heat treatment temperature is to be maintained is 5 minutes or less, it is not preferable in that a sufficient conductivity may not be obtained. A time longer than the above preferable times does not introduce a problem from the point of view of characteristics, however, the time is preferably 6 hours or less when the manufacturing cost is taken into consideration.

The sintered body in the present invention may be manufactured by forming a molded body from a composite powder of calcium compound, aluminum compound, calcium aluminate, and the like, and carrying out the firing under the above described conditions. Because 1200° C. to 1415° C. is the temperature at which the mayenite compound is synthesized, the sintered body of the conductive mayenite compound may be obtained. According to this method, the manufacturing of the mayenite compound and the manufacturing of the sintered body of the mayenite compound power may be achieved simultaneously.

The sintered body obtained by the above described method may be subjected to a process in order to be formed into a desired shape if necessary. The method of processing the sintered body into the desired electrode shape is not limited to a particular method. However, examples of the method may include machining, electrical discharge machining, laser beam machining, and the like. The electrode for the discharge lamp according to the present invention may be obtained by processing the shape of the electrode for the discharge lamp to a desired shape, such as a cup shape, a strip shape, a flat plate shape, and the like.

[Plasma Treatment Process]

The plasma treatment process subjects the surface of the surface layer of the sintered body of the mayenite compound coated on the electrode or forming at least a part of the electrode, to the plasma, in order to facilitate the secondary electron emission.

The plasma is preferably generated from a gas having a pressure of 0.1 Pa to 10000 Pa and selected from a noble gas, hydrogen, and a mixed gas of the noble gas and hydrogen, and further including mercury gas in the selected one of the noble gas, hydrogen gas, and the mixed gas. These gases may further include an inert gas. By subjecting the mayenite compound to such plasma, the performance of the secondary electron emission from the surface layer may be improved considerably.

The plasma treatment may generate the plasma from the gas sealed within a chamber or, spray the plasma generated by a plasma generating apparatus on the surface of the mayenite compound. The time for which the mayenite compound is subjected to the plasma may depend on the kind of mayenite compound, and may be approximately 5 hours or less.

It is particularly preferable that the plasma generating method prepares the opposing electrode and applies the AC voltage across the electrodes. This is because the mayenite compound is essentially an insulator when the electron density of the mayenite compound is low, and the plasma is easy to maintain when the mayenite compound is arranged. The power of the AC voltage that is applied is preferably 0.1 W to 1000 W.

A frequency of the AC voltage is not limited to a particular frequency, and may be 100 Hz to 50 GHz, for example. The frequency may be in the RF range, the VHF range, and the microwave frequency range, for example. Normally, the frequencies used for these ranges are 13.56 MHz, on the order of 40 MHz to 120 MHz, and 2.45 GHz. Amongst these frequencies, 13.56 MHz is further preferable from the point of view of the ease with which the plasma generating apparatus using this frequency may be acquired.

As a concrete example, opposing flat plate electrodes may be arranged within the chamber, and argon gas of 1000 Pa to 10000 Pa is filled into the chamber. Examples of the material forming the flat plate electrodes include nickel and molybdenum. The AC voltage of the above described condition is applied across the electrodes within the chamber, in order to generate the plasma between the electrodes. For example, the AC voltage may have a frequency of 1 kHz to 120 MHz, and the voltage may be applied at an output of 5 W to 100 W.

Another example arranges the electrodes formed with the mayenite compound or, the electrodes having at least a part thereof formed by the sintered body of the mayenite compound, and subjects the surface of the surface layer of the mayenite compound to the plasma for a predetermined time. The time for which the mayenite compound is subjected to the plasma in a case in which the H⁻ ion density of the mayenite compound is lower than 1.0×10¹⁵ cm⁻³ is 0.01 second to 10 minutes when the electron density is 1.0×10¹⁷ cm⁻³ or higher, 0.1 second to 30 minutes when the electron density is 1.0×10¹⁵ cm⁻³ or higher and lower than 1.0×10¹⁷ cm⁻³, and 10 minutes to 5 hours when the electron density is lower than 1.0×10¹⁵ cm⁻³. The time for which the mayenite compound is subjected to the plasma in a case in which the H⁻ ion density of the mayenite compound is 1.0×10¹⁵ cm⁻³ or higher is 0.01 second to 10 minutes.

A description will be given of a particularly preferable example of the plasma treatment method. The cold cathode fluorescent lamp is filled with a mixed gas of the noble gas and mercury gas at a pressure on the order of 1000 Pa to 10000 Pa, and the plasma discharge of the mixed gas is generated by applying the AC voltage of several tens of kHz when turning on the lamp as a product. For this reason, the plasma treatment may be performed by the plasma generated by the AC discharge within the cold cathode fluorescent lamp when the lamp is turned on as a product or, during the discharge lamp manufacturing process. In the example in which the plasma treatment is performed when the lamp is turned on as a product, it is further preferable in that a special plasma treatment process may be omitted when manufacturing the cold cathode and the cold cathode fluorescent lamp.

After the surface of the surface layer of the mayenite compound is plasma treated, the surface is preferably not exposed to the air. This is because the plasma treated surface, when exposed to oxygen and water vapor within the air, may change the surface state thereof and deteriorate the performance of the secondary electron emission. Accordingly, it is particularly desirable to manufacture the product in a state in which the plasma treated surface is not exposed to the air.

The electrode provided with the mayenite compound 9 having the surface of the surface layer thereof plasma treated in advance, may be mounted within the glass tube 1 without being exposed to the atmosphere. In addition, the atmosphere may be replaced by the discharge gas in a state in which the mayenite compound 9 is arranged inside the glass tube 1 in advance. In this case, the discharge gas may be sealed after the plasma treatment without exposing the plasma treated surface to the atmosphere. Alternatively, an AC voltage may be applied across the electrodes after the discharge gas is sealed, in order to generate the plasma that subjects the surface of the surface layer of the mayenite compound to the plasma treatment.

According to the present invention, it is possible to provide the discharge lamp having the above described electrode for the discharge lamp, or the electrode for the discharge lamp manufactured according to the above described method of manufacturing the electrode for the discharge lamp. The discharge lamp of the present invention includes the mayenite compound in at least a part of the electrode for the discharge lamp, and the surface of the surface layer of this mayenite compound is plasma treated, and for this reason, the cathode fall voltage is low and the power consumption is low.

In addition, the life of the electrode for the discharge lamp may be lengthened because the resistance thereof to sputtering is improved. More particularly, by subjecting the surface of the surface layer of the mayenite compound forming at least a part of the cold cathode to the plasma, it becomes possible to provide a cold cathode fluorescent lamp having a cathode fall voltage that is lower than that for cases in which nickel, molybdenum, tungsten, niobium, and alloys of iridium and rhodium are used for the cold cathode. Furthermore, the life of the cold cathode fluorescent lamp of the present invention may be lengthened because the resistance of the cold cathode to the sputtering is improved.

Moreover, according to the present invention, it is possible to provide a discharge lamp characterized in that there are provided a fluorescent tube, a discharge gas sealed inside the discharge lamp, and a mayenite compound provided inside the discharge lamp at a part making contact with the discharge gas, wherein mayenite compound includes a surface layer having a plasma treated surface. More particularly, it is possible to provide the cold cathode fluorescent lamp illustrated in the figures of the embodiments.

The cold cathode fluorescent lamp includes the fluorescent tube having the phosphor 3 coated on the inner surface of the glass tube 1, and the discharge gas sealed inside the cold cathode fluorescent lamp and including argon (Ar), neon (Ne), and mercury (Hg) for exciting the phosphor. In addition, the electrodes 5A and 5B forming the pair of cup-shaped cold cathodes arranged symmetrically inside the glass tube 1 is covered or coated with the mayenite compound.

The mayenite compound may be mixed into the phosphor 3, and may be arranged within the cold cathode fluorescent lamp at a position subjected to the plasma generated by the discharge. Such a cold cathode fluorescent lamp has a cathode fall voltage lower than that of the conventional fluorescent lamp using nickel, molybdenum, tungsten, niobium, and alloys of iridium and rhodium for the cold cathode, which results in a lower power consumption. Further, the life of such a cold cathode fluorescent lamp is lengthened because the resistance of the cold cathode to the sputtering is improved.

### PRACTICAL EXAMPLES

### Manufacture of Mayenite Compound

Calcium carbonate and aluminum oxide were mixed and adjusted to a mole fraction of 12:7, and maintained at 1300° C. for 6 hours in atmosphere in order to manufacture a bulk of 12CaO—7Al₂O₃ compound. An automatic mortar grinder was used to grind this bulk in order to obtain powder A1. The particle size of this powder A1 was measured by a laser diffraction scattering method (SALD-2100 manufactured by Shimadzu Corporation), and the average particle diameter was 20 μm.

It was found from an X-ray diffraction that the powder A1 includes only the 12CaO—7Al₂O₃ structure. In addition, the electron density obtained by a measurement using the ESR apparatus was less than 1.0×10¹⁵ cm⁻³. It was found that the powder A1 is a mayenite compound.

<Manufacture of Mayenite Compound Paste>

Next, a wet ball mill was used to further grind the powder A1 using isopropyl alcohol as the solvent. After the grinding, the powder A1 was subjected to suction filtration and dried in air at 80° C. in order to obtain powder A2. The average particle diameter of the powder A2 measured by the laser diffraction/scattering method described above was 5 μm. Butyl carbitol acetate, terpineol, and ethylcellulose were added to the powder A2 with a weight ratio so that [powder A2]:[butyl carbitol acetate]:[terpineol]:[ethylcellulose] becomes 6:2.4:1.2:0.4 and kneaded by the automatic mortar grinder, and further subjected to a precision kneading using a centrifugal mixer in order to obtain a paste A.

<Electrode Forming Process 1>

Next, the paste A was coated on a nickel metal substrate that is commercially available using screen printing. The nickel metal substrate used had a square size with a side of 15 mm, a thickness of 1 mm, and a purity of 99.9%. The nickel metal substrate was subjected to ultrasonic cleaning using isopropyl alcohol and dried by nitrogen blow, before being used. The paste A was coated to a square having a side of 10 mm by the screen printing. The paste A was coated to a wet thickness of 50 μm, and a dry layer A was obtained by drying an organic solvent at 80° C. The thickness of the dry layer A was 30 μm.

<Electrode Forming Process 2>

Next, the dry layer A on the nickel metal substrate was subjected to a heat treatment. The nickel metal substrate coated with the dry layer A was set on an alumina plate, and the alumina plate carrying the nickel metal substrate was set in a molybdenum container. The molybdenum container was exhausted to 10⁻⁴ Pa at room temperature, and heated to 500° C. in 15 minutes. This state was maintained for 30 minutes in order to remove the binder, and then further heated to 1300° C. in 24 minutes. After the heat treatment at 1300° C. for 30 minutes, a quick cooling was made to room temperature in order to obtain a sample A, which is the nickel metal substrate coated with the mayenite compound. The coated part of the sample A appeared white in color, and was not conductive when tested by a tester. The film thickness of the coated part of the sample A was 20 μm. It was found from an X-ray diffraction that the sample A includes only the 12CaO—7Al₂O₃ structure, and was the mayenite compound. In addition, the electron density obtained by a measurement using the ESR apparatus was less than 1.0×10¹⁵ cm⁻³. Further, when an ultraviolet (UV) ray was irradiated on the coated part to transform the H⁻ ions into electrons before measuring the electron density in order to calculate the H⁻ ion density, the calculated electron density showed no change, and the calculated H⁻ ion density was less than 1.0×10¹⁵ cm⁻³.

<Plasma Treatment Process>

Next, the sample A was set in a vacuum chamber of the open cell discharge measuring apparatus illustrated in FIG. 2. Molybdenum metal was used for the opposing electrode. The inter-electrode distance between the electrodes was approximately 1.48 mm. A tool made of silica glass for handing the sample was used when setting the cathode and the anode. The chamber was exhausted to 5×10⁻³ Pa before filling argon gas to 3700 Pa, and the plasma treatment was carried out at a frequency of 10 kHz and an output of 6.4 W for 3 hours. It was found from an X-ray diffraction that the sample A after the plasma treatment includes only the 12CaO—7Al₂O₃ structure, and was the mayenite compound. In addition, the electron density obtained by a measurement using the ESR apparatus was less than 1.0×10¹⁵ cm⁻³. Further, when an UV ray was irradiated on the coated part to transform the H⁻ ions into electrons before measuring the electron density in order to calculate the H⁻ ion density, the calculated electron density showed no change, and the calculated H⁻ ion density was less than 1.0×10¹⁵ cm⁻³.

<Measurement of Cathode Fall Voltage>

The cathode fall voltage was measured using an open cell discharge measuring apparatus. For example, the open cell discharge measuring apparatus illustrated in FIG. 2 was used. In an open cell discharge measuring apparatus 30, two samples (sample 1 and sample 2) oppose each other within a vacuum chamber 31, and an AC or DC voltage is applied between the two samples after filling a noble gas such as argon, and a mixed gas of the noble gas and hydrogen. The cathode fall voltage was measured by causing a discharge between the samples. In this state, the cold cathode, which is the sample, may have the shape of any one of the cup-shaped cold cathode, the strip-shaped cold cathode, the flat plate-shaped cold cathode, and cold cathodes having other shapes.

### Practical Example 1

<Measurement of Cathode Fall Voltage (Part 1)>

In the <Plasma Treatment Process> described above, the vacuum chamber is first exhausted to 3×10⁻⁴ Pa without releasing the inside to the atmosphere after the plasma treatment, and argon gas was again filled to 3700 Pa.

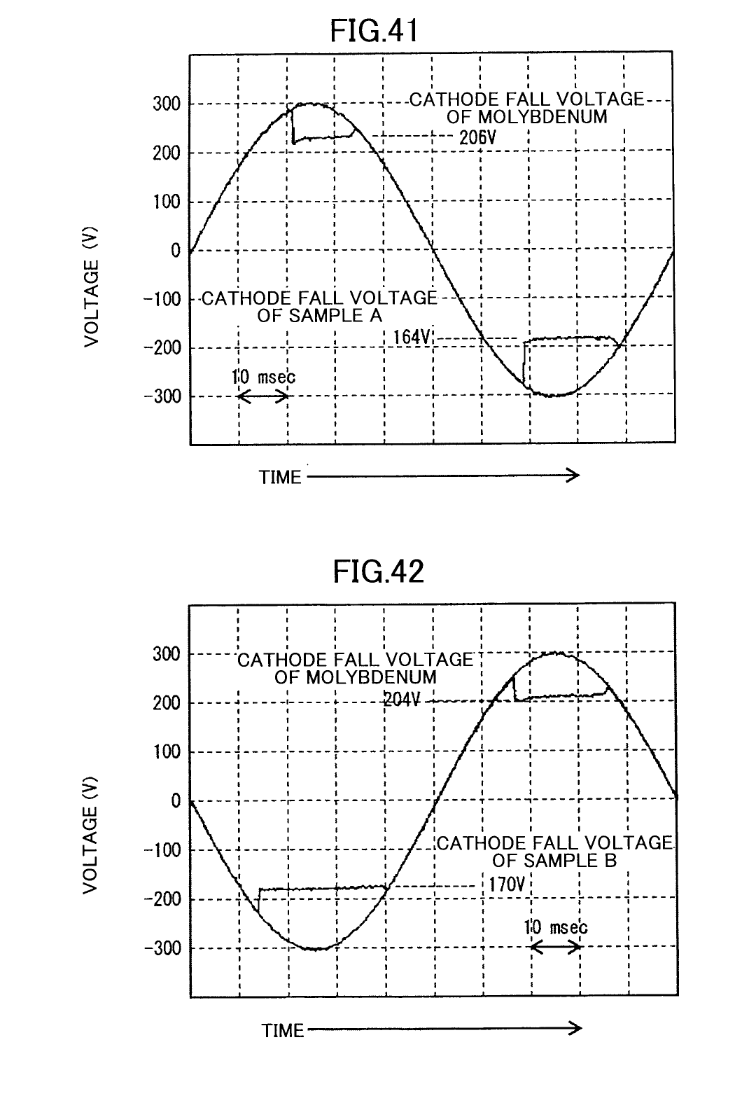

Next, as illustrated in FIG. 41, an AC voltage of 600 V peak-to-peak at 10 Hz was applied, and the measured cathode fall voltage of the sample A after the plasma treatment was 164 V when a product Pd is approximately 4.1 Torr·cm, where P denotes the gas pressure within the vacuum chamber and d denotes the distance between the cathode and the anode. On the other hand, the cathode fall voltage for the molybdenum metal was 206 V. Accordingly, it was confirmed that the cathode fall voltage of the sample A after the plasma treatment is 20% lower with respect to that of the molybdenum metal.

### Practical Example 2

<Measurement of Cathode Fall Voltage (Part 2)>

A sample B, which is nickel metal substrate coated with hydrogenated mayenite compound, was obtained in a manner similar to that of the above <Electrode Forming Process 2>, except for a heat treatment that was carried out in a hydrogen atmosphere at a pressure of 0.1 MPa. The coated part of the sample B appeared light yellow in color, and was not conductive when tested by a tester. The electron density obtained by a measurement using the ESR apparatus was less than 1.0×10¹⁵ cm⁻³. Further, when an UV ray was irradiated on the coated part to transform the H⁻ ions into electrons before measuring the electron density in order to calculate the H⁻ ion density, the calculated H⁻ ion density was 7.3×10¹⁸ cm⁻³. It was found from an X-ray diffraction that the sample B includes only the 12CaO—7Al₂O₃ structure. Next, a plasma treatment was carried out in a manner similar to that of the above <Plasma Treatment Process>, except that the sample B was subjected to the plasma for 5 seconds. It was found from an X-ray diffraction that the sample B after the plasma treatment includes only the 12CaO—7Al₂O₃ structure, and was the mayenite compound. In addition, the electron density obtained by a measurement using the ESR apparatus was less than 1.0×10¹⁵ cm⁻³. Further, when an UV ray was irradiated on the coated part to transform the H⁻ ions into electrons before measuring the electron density in order to calculate the H⁻ ion density, the calculated H⁻ ion density was 7.3×10¹⁸ cm⁻³ and unchanged from the value before the plasma treatment.

After the plasma treatment, the vacuum chamber was exhausted to 3×10⁻⁴ Pa, and argon gas was again filled to 1850 Pa.

Next, as illustrated in FIG. 42, an AC voltage of 600 V peak-to-peak at 10 Hz was applied, and the measured cathode fall voltage of the sample B after the plasma treatment was 170 V when the product Pd is approximately 2.1 Torr·cm. On the other hand, the cathode fall voltage for the molybdenum metal was 204 V. Accordingly, it was confirmed that the cathode fall voltage of the sample B after the plasma treatment is 17% lower with respect to that of the molybdenum metal.

### Practical Example 3

<Measurement of Cathode Fall Voltage (Part 3)>

The powder A2 was formed to a disk-shaped molded body having a diameter of 1 cm and a thickness of 2 mm by press molding at a pressure of 2 MPa. In addition, this molded body was heated to 1350° C. in air to obtain a sintered body. The sintered body obtained was set in an alumina container having a bottom thereof covered with aluminum metal powder, and an alumina lid was put on the alumina container. The alumina container closed by the alumina lid was heated to 1300° C. under vacuum of 10⁻³ Pa or less, and a reduced sintered body was obtained. The reduced sintered body obtained appeared black in color. A grinding method similar to that used for the powder A2 was used to grind the reduced sintered body in order to obtain black powder having an average particle diameter of 5 μm. The electron density of this black powder measured from the diffuse reflectance spectrum by the Kubelka-Munk method was 1×10²¹ cm⁻³. In addition, it was found from an X-ray diffraction that the black powder includes only the 12CaO—7Al₂O₃ structure.

A paste C was obtained in a manner similar to that of the above <Manufacture of Mayenite Compound Paste>, except that the mayenite compound having the electron density of 1×10²¹ cm⁻³ was used as the powder A2. In addition, a sample C, which is a nickel metal substrate coated with hydrogenated mayenite compound, was obtained in a manner similar to that of the above <Electrode Forming Process 2>, except that a heat treatment at 1340° C. was carried out in a hydrogen atmosphere at a pressure of 0.1 MPa.

The coated part of the sample C appeared light yellow in color, and was not conductive when tested by a tester. The electron density obtained by a measurement using the ESR apparatus was less than 1.0×10¹⁵ cm⁻³. Further, when an UV ray was irradiated on the coated part to transform the H⁻ ions into electrons before measuring the electron density in order to calculate the H⁻ ion density, the calculated H⁻ ion density was 3.3×10²⁰ cm⁻³. In addition, it was found from an X-ray diffraction that the sample C includes only the 12CaO—7Al₂O₃ structure.

Moreover, a plasma treatment was carried out in a manner similar to that of the above <Plasma Treatment Process>, except that the inter-electrode distance was set to approximately 1.63 mm and the sample C was subjected to the plasma for 1 second. It was found from an X-ray diffraction that the sample C after the plasma treatment includes only the 12CaO—7Al₂O₃ structure, and was the mayenite compound. In addition, the electron density obtained by a measurement using the ESR apparatus was less than 1.0×10¹⁵ cm⁻³. Further, when an UV ray was irradiated on the coated part to transform the H⁻ ions into electrons before measuring the electron density in order to calculate the H⁻ ion density, the calculated H⁻ ion density was 3.3×10²⁰ cm⁻³ and unchanged from the value before the plasma treatment. After the plasma treatment, the vacuum chamber was exhausted to 3×10⁻⁴ Pa, and argon gas was again filled to 3200 Pa.

Next, as illustrated in FIG. 43, an AC voltage of 800 V peak-to-peak at 10 Hz was applied, and the measured cathode fall voltage of the sample C after the plasma treatment was 140 V when the product Pd is approximately 3.9 Torr·cm. On the other hand, the cathode fall voltage for the molybdenum metal was 218 V. Accordingly, it was confirmed that the cathode fall voltage of the sample C after the plasma treatment is 36% lower with respect to that of the molybdenum metal.

### Practical Example 4

<Measurement of Cathode Fall Voltage (Part 4)>

1 weight % of polyvinyl alcohol was added to the powder A2 obtained by the above <Manufacture of Mayenite Compound Paste> and kneaded, and a molded body of 2×2×2 cm³ was obtained by uniaxial press molding. This molded body was set in a carbon container with a lid, and the carbon container with the lid was placed inside an electric furnace. The electric furnace was exhausted to 10⁻⁴ Pa at room temperature, and heated to 1300° C. in 39 minutes. After a heat treatment at 1300° C. for 2 hours, a quick cooling was made to room temperature in order to obtain a sintered body.

Next, cutting and polishing processes were carried out on the sintered body using no water, in order to obtain a cylindrical sample D with a covered bottom, having an outer diameter of 8 mm, an inner diameter of 5 mm, a height of 16 mm, and a depth of 5 mm. It was found from an X-ray diffraction that the sample D includes only the 12CaO—7Al₂O₃ structure. The electron density of the sample D measured from the diffuse reflectance spectrum by the Kubelka-Munk method was 1.0×10¹⁹ cm⁻³, and the sample D was found to be a conductive mayenite compound. In addition, an UV ray was irradiated on the coated part to transform the H⁻ ions into electrons before measuring the electron density in order to calculate the H⁻ ion density, the calculated electron density showed no change, and the calculated H⁻ ion density was less than 1.0×10¹⁵ cm⁻³.

The sample D appeared black in color. Molybdenum electrodes having the same shape as the sample D were provided within a glass tube having an outer diameter of 20 mm to oppose each other with an inter-electrode distance of approximately 10 mm. 120 mg of liquid mercury was dropped into the glass tube and an exhaust pipe was connected thereto. The glass tube was exhausted to 10⁻⁵ Pa before filling argon gas to 3000 Pa, and was then sealed. The mercury within the sealed glass tube was gasified by high-frequency heating, so that the inside of the glass tube is a mixed gas atmosphere of argon and mercury.

Further, a plasma treatment was carried out at a frequency of 10 kHz and an output of 10 W for 10 seconds. It was found from an X-ray diffraction that the sample D after the plasma treatment includes only the 12CaO—7Al₂O₃ structure, and was the mayenite compound. The electron density of the sample measured from the diffuse reflectance spectrum by the Kubelka-Munk method was 1.0×10¹⁹ cm⁻³. Further, when an UV ray was irradiated on the coated part to transform the H⁻ ions into electrons before measuring the electron density in order to calculate the H⁻ ion density, the calculated electron density showed no change, and the calculated H⁻ ion density was less than 1.0×10¹⁵ cm⁻³.

Next, a DC voltage applied across the electrodes was varied while measuring the cathode fall voltage of the sample D. The measured cathode fall voltage of the sample D after the plasma treatment was 143 V when the product Pd is approximately 22.6 Torr·cm. On the other hand, the cathode fall voltage for the molybdenum metal was 204 V. Accordingly, it was confirmed that the cathode fall voltage of the sample D after the plasma treatment is 30% lower with respect to that of the molybdenum metal because virtually no positive column is generated in this state.

<Resistance of Mayenite Compound To Sputtering>

In the above <Measurement of Cathode Fall Voltage (Part 4)>, an AC voltage of 800 V peak-to-peak at 50 kHz was applied, and the glow discharge was continued for 1000 hours. The glass tube near the molybdenum metal electrodes became black due to deposits, and it was confirmed that the molybdenum was sputtered. On the other hand, no deposits were observed in the glass tube near the electrodes of the sample D, and no change in external appearance was observed in that the glass tube was colorless and transparent near the electrodes of the sample D. Hence, it was confirmed that the resistance of the plasma treated sample D, that is, the mayenite compound, to the sputtering is extremely superior when compared to that of the molybdenum metal.

### Practical Example 5

<Measurement of Cathode Fall Voltage (Part 5)>

The powder A2 was formed to a disk-shaped molded body having a diameter of 1 cm and a thickness of 2 mm by press molding at a pressure of 2 MPa. In addition, this molded body was heated to 1350° C. in air to obtain a sintered body. The sintered body obtained was set in an carbon container having a lid, and the carbon container closed by the lid was heated to 1300° C. under vacuum of 10⁻³ Pa or less, and a reduced sintered body was obtained. The reduced sintered body obtained appeared black in color. A grinding method similar to that used for the powder A2 was used to grind the reduced sintered body in order to obtain dark green powder having an average particle diameter of 5 μm. The electron density of this dark green powder measured from the diffuse reflectance spectrum by the Kubelka-Munk method was 1×10¹⁹ cm⁻³. In addition, it was found from an X-ray diffraction that the dark green powder includes only the 12CaO—7Al₂O₃ structure.

A paste E was obtained in a manner similar to that of the above <Manufacture of Mayenite Compound Paste>, except that the mayenite compound having the electron density of 1×10¹⁹ cm⁻³ was used as the powder A2. In addition, a sample E1, which is a nickel metal substrate coated with conductive mayenite compound, was obtained in a manner similar to that of the above <Electrode Forming Process 2>, except that the nickel metal substrate was set in a carbon container with a lid in place of the molybdenum container.

The coated part of the sample E1 appeared green in color. The electron density of the sample E1 measured from the diffuse reflectance spectrum by the Kubelka-Munk method was 1.4×10¹⁹ cm⁻³. Further, when an UV ray was irradiated on the coated part to transform the H⁻ ions into electrons before measuring the electron density in order to calculate the H⁻ ion density, the calculated electron density showed no change, and the calculated H⁻ ion density was less than 1.0×10¹⁵ cm⁻³. In addition, it was found from an X-ray diffraction that the sample E1 includes only the 12CaO—7Al₂O₃ structure.

Moreover, a plasma treatment was carried out in a manner similar to that of the above <Plasma Treatment Process>, except that the inter-electrode distance was set to approximately 1.63 mm and the sample E1 was subjected to the plasma for 30 seconds. It was found from an X-ray diffraction that the sample E1 after the plasma treatment includes only the 12CaO—7Al₂O₃ structure, and was the mayenite compound. The electron density measured from the diffuse reflectance spectrum by the Kubelka-Munk method was 1.4×10¹⁹ cm⁻³, and unchanged from the value before the plasma treatment. Further, when an UV ray was irradiated on the coated part to transform the H⁻ ions into electrons before measuring the electron density in order to calculate the H⁻ ion density, the calculated electron density showed no change, and the calculated H⁻ ion density was less than 1.0×10¹⁵ cm⁻³ and unchanged from the value before the plasma treatment.

After the plasma treatment, the vacuum chamber was exhausted to 3×10⁻⁴ Pa, and argon gas was again filled to 4400 Pa.

Next, a DC voltage applied across the electrodes was varied while measuring the cathode fall voltage of the sample E1. The measured cathode fall voltage of the sample E1 after the plasma treatment was 152 V when the product Pd is approximately 5.4 Torr·cm. On the other hand, the cathode fall voltage for the molybdenum metal was 212 V. Accordingly, it was continued that the cathode fall voltage of the sample E1 after the plasma treatment is 28% lower with respect to that of the molybdenum metal.

### Practical Example 6

Next, a heat treatment was carried out on the plasma treated sample E1 by assuming a sealing process during the manufacture of the cold cathode fluorescent lamp. In the sealing process of the cold cathode fluorescent lamp, the sealing was made within an inert gas such as argon at 400° C. to 500° C. for approximately 1 minute. Hence, in a state in which the sample E1 is set in an open cell discharge measuring apparatus, a heat treatment was carried out in which argon was used as the inert gas at a pressure of 1.1×10⁵ Pa, the heating to 500° C. was made in 15 minutes and 500° C. is maintained for 1 minute at 500° C., and a quick cooling was made. As a result, a sample E2, which is the nickel metal substrate coated with the conductive mayenite compound, was obtained.

The sample E2 appeared white in color. The electron density of the sample E2 obtained by a measurement using the ESR apparatus was 8.3×10¹⁶ cm⁻³. Further, when an UV ray was irradiated on the coated part to transform the H⁻ ions into electrons before measuring the electron density in order to calculate the H⁻ ion density, the calculated electron density showed no change, and the calculated H⁻ ion density was less than 1.0×10¹⁵ cm⁻³. In addition, it was found from an X-ray diffraction that the sample E2 includes only the 12CaO—7Al₂O₃ structure.

Thereafter, the vacuum chamber was exhausted to 3×10⁻⁴ Pa, and argon gas was again filled to 4400 Pa. The inter-electrode distance was set to approximately 1.63 mm, and the DC voltage applied across the electrodes was varied in order to measure the cathode fall voltage of the sample E2, however, no discharge occurred and the cathode fall voltage could not be measured.

Next, a plasma treatment was carried out in a manner similar to that of the above <Plasma Treatment Process>, except that the inter-electrode distance was set to approximately 1.63 mm and the sample E2 was subjected to the plasma for 30 seconds. It was found from an X-ray diffraction that the coated part of the sample E2 after the plasma treatment includes only the 12CaO—7Al₂O₃ structure, and was the mayenite compound. In addition, the electron density obtained by a measurement using the ESR apparatus was less than 8.3×10¹⁶ cm⁻³ and unchanged from the value before the plasma treatment. Further, when an UV ray was irradiated on the coated part to transform the H⁻ ions into electrons before measuring the electron density in order to calculate the H⁻ ion density, the calculated electron density showed no change, and the calculated H⁻ ion density was less than 1.0×10¹⁵ cm⁻³.

After the plasma treatment, the vacuum chamber was exhausted to 3×10⁻⁴ Pa, and argon gas was again filled to 4700 Pa.

Next, a DC voltage applied across the electrodes was varied while measuring the cathode fall voltage of the sample E2. The measured cathode fall voltage of the sample E2 after the plasma treatment was 150 V when the product Pd is approximately 5.7 Torr·cm. On the other hand, the cathode fall voltage for the molybdenum metal was 206 V. Accordingly, it was confirmed that the cathode fall voltage of the sample E2 after the plasma treatment is 27% lower with respect to that of the molybdenum metal. It was confirmed that, even when the electron density of the coated mayenite compound decreases due to the heat treatment or the like, the cathode fall voltage may be reduced by carrying out the plasma treatment.

### Practical Example 7

### Measurement of Cathode Fall Voltage

### Part 6

1 weight % of polyvinyl alcohol was added to the powder A2 and kneaded, and a molded body of 2×4×2 cm³ was obtained by uniaxial press molding. This molded body was heated to 1350° C. in air in 4 and a half hour. After a heat treatment at 1350° C. for 6 hours, a cooling was made to room temperature in 4 and a half hour in order to obtain a sintered body of a compact mayenite compound. The sintered body of the mayenite compound appeared white in color, and the electron density was less than 1.0×10¹⁵ cm⁻³. The sintered body of the mayenite compound was formed to a cylindrical shape with a covered bottom, having an outer diameter of 2.4 mm, an inner diameter of 2.1 mm, a height of 14.7 mm, and a depth of 9.6 mm.

Furthermore, the following surface treatment was carried out. That is, after setting the sintered body having the cylindrical shape with the covered bottom and made of the mayenite compound into a carbon container with a lid, the carbon container with the lid was placed inside an electric furnace. The furnace was exhausted until an air pressure became 2 Pa or less, and 0.6 ppm of oxygen and nitrogen having a dew point of −90° C. were supplied to the furnace before returning the pressure inside the furnace to the atmospheric pressure. The supply of nitrogen was thereafter continued at a flow rate of 5 L/minute. The electric furnace was provided with a relief valve so that a pressure which is 12 kPa or more higher than the atmospheric pressure will not be applied inside the furnace. After heating to 1280° C. in 38 minutes and maintaining 1280° C. for 4 hours, a quick cooling was made to room temperature, in order to obtain a sample F, which is the cold cathode formed by the sintered body of the mayenite compound. The sample F appeared black in color. A plurality of samples F were manufactured simultaneously.

Powder F1 was obtained by grinding the sample F using an automatic mortar grinder. The particle size of this powder F1 was measured by the laser diffraction/scattering method (SALD-2100 manufactured by Shimadzu Corporation), and the average particle diameter was 20 μm. It was found from an X-ray diffraction that the powder F1 includes only the 12CaO—7Al₂O₃ structure. In addition, the electron density measured from the diffuse reflectance spectrum by the Kubelka-Munk method was 1.0×10¹⁹ cm⁻³.

Next, in order to electrically connect lead wires to the sample F, the sample F was calked to an electrode made of nickel metal and having a cylindrical shape with a covered bottom (hereinafter also referred to as a “nickel metal cup”). The nickel metal cup had an outer diameter of 2.7 mm, an inner diameter of 2.5 mm, a height of 5.0 mm, and a depth of 4.7 mm. The “calking” refers to inserting the sample F into the nickel metal cup and fastening the sample F towards the bottom as if turning a screw, so that the sample F and a contact part of the nickel metal cup are rigidly secured. In order to facilitate insertion of the sample F into the nickel metal cup, the inner diameter of the nickel metal cup was 2.5 mm. The nickel metal cup may be provided with a slit in order to facilitate the calking. Kovar wires were connected in advance to the bottom of the nickel metal cup, and thus, the sample F may easily be electrically connected to the lead wires.

Next, a plasma treatment was carried out. The sample F was set in the vacuum chamber 31 of the open cell discharge measuring apparatus 20 illustrated in FIG. 2. The nickel metal cup was provided as the opposing electrode. The nickel metal electrodes were welded to the kovar lead wires in order to extend from the inside of the glass tube to the outside of the glass tube. The distance from the sample F to the opposing electrode was 2.4 mm. The vacuum chamber 31 was initially exhausted to 3×10⁻³ Pa, and argon gas was again filled to 1250 Pa. A plasma treatment was carried out for 10 minutes at DC output of 3.2 W so that the sample F becomes the cathode. The vacuum chamber 31 was exhausted to 3×10⁻⁴ Pa after the plasma treatment, and argon gas was again filled to 2000 Pa.

It was confirmed from an X-ray diffraction that the samples after the plasma treatment under the same conditions include only the 12CaO—7Al₂O₃ structure, and were the mayenite compound. In addition, the electron density measured from the diffuse reflectance spectrum by the Kubelka-Munk method was 1.0×10¹⁹ cm⁻³.

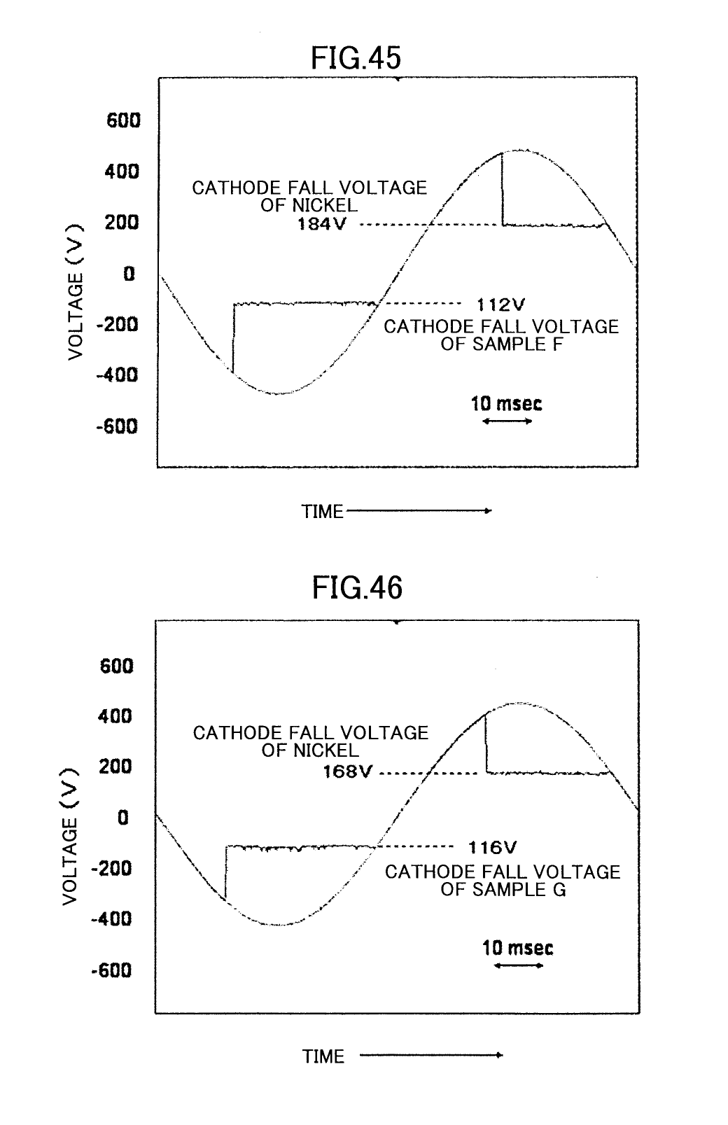

As illustrated in FIG. 45, an AC voltage of 900 V peak-to-peak at 10 Hz was applied, and the measured cathode fall voltage of the sample F was 112 V when the product Pd is approximately 13.9 Torr·cm, where P denotes the gas pressure within the vacuum chamber and d denotes the distance between the cathode and the anode. On the other hand, the cathode fall voltage for the nickel metal was 184 V. Accordingly, it was confirmed that the cathode fall voltage of the sample F is 39% lower with respect to that of nickel metal.

### Practical Example 8

### Measurement of Cathode Fall Voltage

### Part 7

A sintered body of a mayenite compound having an electron density of 1.0×10¹⁹ cm⁻³ was manufactured, instead of a metal cold cathode including the mayenite compound. First, an EVA resin (ethylene-vinyl acetate copolymer) and an acrylic resin were added as binders, a denatured wax was added as a lubricant, and dibutyl phthalate was added as a plasticizer to the mayenite compound powder A2 and kneaded. The compounding ratio in weight of [powder A2]:[EVA resin]:[acrylic resin]:[denatured wax]:[dibutyl phthalate] was 8.0:0.8:1.2:1.6:0.4. A molded body having a cylindrical shape with a covered bottom was manufactured by injection molding of the powder A2 in the mixed state.

Next, the molded body was maintained in air at 520° C. for 3 hours in order to remove the binder component. Further, the molded body was maintained in air at 1300° C. for 2 hours in order to obtain a sintered body of the mayenite compound. The sintered body of the mayenite compound was set in a carbon container with a lid, and the carbon container with the lid was subjected to a heat treatment within nitrogen at 1280° C. for 30 minutes. As a result, a sample G, which is a mayenite compound having an electron density of 1.0×10¹⁹ cm⁻³ was obtained. The sintered body in this state had an outer diameter of 1.9 mm, a height of 9.2 mm, a depth of 8.95 mm, and a thickness of 0.25 mm.

The sample G was calked to a nickel metal cup in a manner similar to the above <Measurement of Cathode Fall Voltage (Part 6)>. The nickel metal cup had an outer diameter of 2.7 mm, an inner diameter of 2.5 mm, a height of 10.0 mm, and a depth of 9.7 mm. Next, a plasma treatment was carried out. The sample G was set in the vacuum chamber 31 of the open cell discharge measuring apparatus 30 illustrated in FIG. 2. The nickel metal cup was provided as the opposing electrode. The nickel metal electrode was welded to the kovar lead wire in order to extend from the inside of the glass tube to the outside of the glass tube. The distance from the sample G to the opposing electrode was 3.0 mm. The vacuum chamber 31 was initially exhausted to 9×10⁻⁴ Pa, and argon gas was again filled to 3000 Pa. A plasma treatment was carried out for 10 minutes at DC output of 7.2 W so that the sample G becomes the cathode. The vacuum chamber 31 was exhausted to 3×10⁻⁴ Pa after the plasma treatment, and argon gas was again filled to 2000 Pa.

As illustrated in FIG. 46, an AC voltage of 900 V peak-to-peak at 10 Hz was applied, and the measured cathode fall voltage of the sample G was 116 V when the product Pd is approximately 8.6 Torr·cm, where P denotes the gas pressure within the vacuum chamber and d denotes the distance between the cathode and the anode. On the other hand, the cathode fall voltage for the nickel metal was 168 V. Accordingly, it was confirmed that the cathode fall voltage of the sample G is 31% lower with respect to that of nickel metal.

### Practical Example 9

### Measurement of Cathode Fall Voltage

### Part 8

In the above <Electrode Forming Process 1>, a rod electrode having a cylindrical column shape was manufactured in place of the substrate. The rod electrode was made of molybdenum metal, and had a diameter of 2.7 mm and a length of 15 mm. The paste E was coated on an end part and a side surface of the electrode, to a length of 7 mm from the end part of the electrode. The paste E was also coated on a top surface of the cylindrical column shape forming a tip end of the electrode. In addition, an organic solvent was dried at 80° C., in order to obtain a dry layer L coating the molybdenum metal rod. The thickness of the dry layer L was 30 μm. Next, the following surface treatment was carried out. That is, after setting the dry layer L within a carbon container with a lid, the carbon container with the lid was placed inside an electric furnace having an adjustable atmosphere. The air within the furnace was exhausted until the pressure became 2 Pa or less, and 0.6 ppm of oxygen and nitrogen having a dew point of −90° C. were supplied to the furnace before returning the pressure inside the furnace to the atmospheric pressure. The supply of nitrogen was thereafter continued at a flow rate of 5 L/minute. The electric furnace was provided with a relief valve so that a pressure which is 12 kPa or more higher than the atmospheric pressure will not be applied inside the furnace. After heating to 1300° C. in 41 minutes and maintaining 1300° C. for 30 minutes, a quick cooling was made to room temperature, in order to obtain the sample L.

It was found from an X-ray diffraction that the coated part of the sample L includes only the 12CaO—7Al₂O₃ structure, and is a mayenite compound. In addition, the electron density of the mayenite compound at the coated part measured from the diffuse reflectance spectrum by the Kubelka-Munk method was 3.7×10¹⁹ cm⁻³.

Next, a plasma treatment was carried out. The sample L was set in the vacuum chamber 31 of the open cell discharge measuring apparatus 30 illustrated in FIG. 2. The molybdenum metal having the same rod shape as the sample L was provided as the opposing electrode. The molybdenum metal electrode was welded to the kovar lead wire in order to extend from the inside of the glass tube to the outside of the glass tube in order to easily achieve electrical connection. The distance from the sample L to the opposing electrode was 3.0 mm. The vacuum chamber 31 was initially exhausted to 3×10⁻⁴ Pa, and argon gas was again filled to 3000 Pa. A plasma treatment was carried out for 10 minutes at DC output of 7.2 W so that the sample L becomes the cathode. The vacuum chamber 31 was exhausted to 3×10⁻⁴ Pa after the plasma treatment, and argon gas was again filled to 5500 Pa.

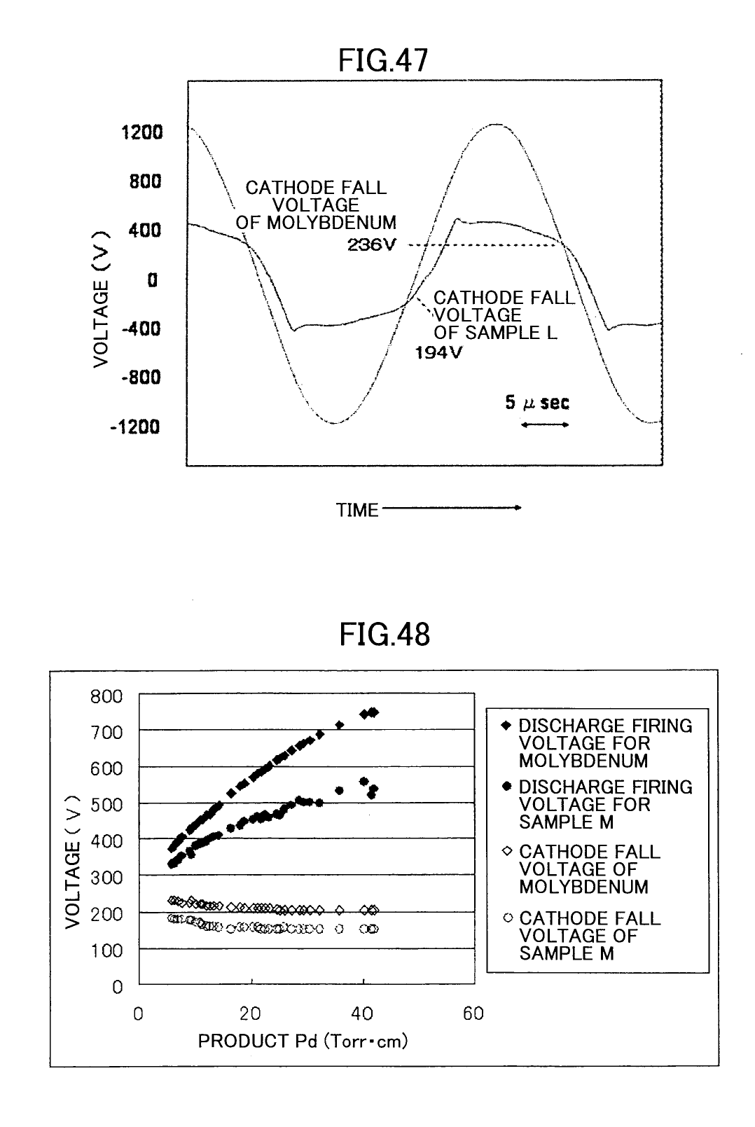

As illustrated in FIG. 47, an AC voltage of 2480 V peak-to-peak at 30 kHz was applied to cause glow discharge, and the measured cathode fall voltage of the sample L was 194 V when the product Pd is approximately 12.4 Torr·cm. On the other hand, the cathode fall voltage for the molybdenum metal was 236 V. Accordingly, it was confirmed that the cathode fall voltage of the sample L is 18% lower with respect to that of the molybdenum metal.

### Practical Example 10

### Measurement of Cathode Fall Voltage & Discharge Firing Voltage

In the above <Electrode Forming Process 1>, a flat plate-shaped electrode was manufactured in place of the substrate. The electrode was made of molybdenum metal, and had a width of 1.5 mm, a length of 15 mm, and a thickness of 0.1 mm. The paste E was coated on both sides of the flat plate-shaped electrode, to a length of 12 mm from an end part of the electrode. In addition, an organic solvent was dried at 80° C., in order to obtain a dry layer M coating the molybdenum metal strip. The thickness of the dry layer M was 30 μm. Next, the following surface treatment was carried out. That is, after setting the dry layer M within a carbon container with a lid, the carbon container with the lid was placed inside an electric furnace having an adjustable atmosphere. The air within the furnace was exhausted until the pressure became 2 Pa or less, and 0.6 ppm of oxygen and nitrogen having a dew point of −90° C. were supplied to the furnace before returning the pressure inside the furnace to the atmospheric pressure. The supply of nitrogen was thereafter continued at a flow rate of 5 L/minute. The electric furnace was provided with a relief valve so that a pressure which is 12 kPa or more higher than the atmospheric pressure will not be applied inside the furnace. After heating to 1300° C. in 41 minutes and maintaining 1300° C. for 30 minutes, a quick cooling was made to room temperature, in order to obtain the sample M. It was found from an X-ray diffraction that the coated part of the sample M includes only the 12CaO—7Al₂O₃ structure, and is a mayenite compound. In addition, the electron density of the mayenite compound at the coated part measured from the diffuse reflectance spectrum by the Kubelka-Munk method was 1.7×10¹⁹ cm⁻³.

Next, a plasma treatment was carried out. The sample M was set in the vacuum chamber 31 of the open cell discharge measuring apparatus 30 illustrated in FIG. 2. The molybdenum metal having the same strip shape as the sample M was provided as the opposing electrode. The molybdenum metal electrode was welded to the kovar lead wire in order to extend from the inside of the glass tube to the outside of the glass tube in order to easily achieve electrical connection. The distance from the sample M to the opposing electrode was 2.8 mm. The vacuum chamber 31 was initially exhausted to 3×10⁻⁴ Pa, and argon gas was again filled to 3000 Pa. A plasma treatment was carried out for 10 minutes at DC output of 7.2 W so that the sample M becomes the cathode. The vacuum chamber 31 was exhausted to 3×10⁻⁴ Pa after the plasma treatment, and argon gas was again filled.

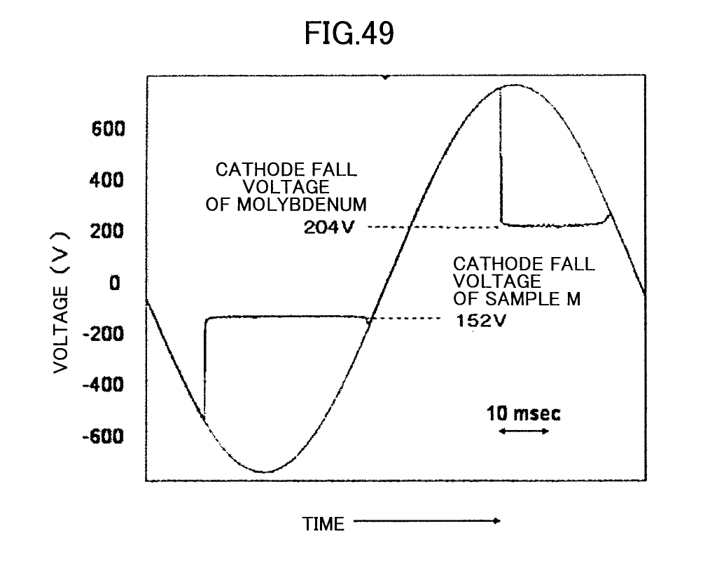

Next, the cathode fall voltage and a discharge firing voltage were measured for the sample M and the molybdenum metal electrode while varying the product Pd. The inter-electrode distance was maintained constant, and only the gas pressure was varied. An AC voltage at 10 Hz was applied. As illustrated in FIG. 48, it was found that the cathode fall voltage and the discharge firing voltage for the sample M were lower than those of the molybdenum metal for all ranges of the product Pd. For example, the cathode fall voltage of the sample M was 152 V and the discharge firing voltage of the sample M was 556 V when the product Pd is 40.3 Torr·cm, as illustrated in FIG. 49. On the other hand, the cathode fall voltage and the discharge firing voltage for the molybdenum metal was 204 V and 744 V, respectively. Accordingly, it was confirmed that the cathode fall voltage of the sample M is 25% lower with respect to that of the molybdenum metal, and that the discharge firing voltage of the sample M is 25% lower with respect to that of the molybdenum metal.

### Comparison Example 1

### Measurement of Cathode Fall Voltage

### Part 9

The above <Plasma Treatment Process> was omitted for the sample A, and an AC voltage of 600 V peak-to-peak at 10 kHz was applied, however, no discharge occurred and the cathode fall voltage could not be measured. It was found from an X-ray diffraction that the coated part of the electrode includes only the 12CaO—7Al₂O₃ structure, and is a mayenite compound. In addition, the electron density of the mayenite compound coated on the electrode, calculated based on a measurement using the ESR apparatus, was less than 1.0×10¹⁵ cm⁻³. Further, when an UV ray was irradiated on the coated part to transform the H⁻ ions into electrons before measuring the electron density in order to calculate the H⁻ ion density, the calculated electron density showed no change, and the calculated H⁻ ion density was less than 1.0×10¹⁵ cm⁻³.

### Comparison Example 2

### Measurement of Cathode Fall Voltage

### Part 10

The above <Plasma Treatment Process> was omitted for the sample B, and an AC voltage of 600 V peak-to-peak at 10 Hz was applied, however, no discharge occurred and the cathode fall voltage could not be measured. It was found from an X-ray diffraction that the coated part of the electrode includes only the 12CaO—7Al₂O₃ structure, and is a mayenite compound. In addition, the electron density of the mayenite compound coated on the electrode obtained by a measurement using the ESR apparatus was less than 1.0×10¹⁵ cm⁻³. Further, when an UV ray was irradiated on the coated part to transform the H⁻ ions into electrons before measuring the electron density in order to calculate the H⁻ ion density, the calculated H⁻ ion density was less than 7.3×10¹⁸ cm⁻³.

As described above, according to the embodiments and practical examples, at least a part of an electrode for a discharge lamp includes a mayenite compound, and a surface of a surface layer of the mayenite compound has been plasma treated in order to reduce a cathode fall voltage and reduce power consumption. More particularly, by subjecting the cold cathode including the mayenite compound in at least a part thereof to the plasma, the cathode fall voltage may be made lower than that for nickel, molybdenum, tungsten, niobium, and alloys of iridium and rhodium. Further, a longer life may be achieved by improving resistance to sputtering.

The present invention is described above in detail with reference to specific embodiments and practical examples, however, it may be apparent to those skilled in the art that various variations and modifications may be made without departing from the spirit and scope of the present invention.

What is claimed is:

1. An electrode for a discharge lamp, comprising:
a mayenite compound in at least a part of the electrode emitting secondary electrons,
wherein a surface of a surface layer of the mayenite compound is plasma treated.

2. The electrode for the discharge lamp as claimed in claim 1, wherein the electrode includes a metal base, and the mayenite compound is provided in at least a part of the metal base.

3. The electrode for the discharge lamp as claimed in claim 1, wherein at least a part of the electrode is formed by a sintered body of the mayenite compound, at least a part of free oxygen ions of the mayenite compound is substituted by electrons, and an electron density is 1×10¹⁹ cm⁻³ or higher.

4. The electrode for the discharge lamp as claimed in claim 1, wherein the surface of the surface layer of the mayenite compound is plasma treated by plasma generated by discharge.

5. The electrode for the discharge lamp as claimed in claim 1, wherein the surface of the surface layer of the mayenite compound is plasma treated by plasma of at least one kind of gas selected from a group consisting of noble gas and hydrogen or, by plasma of a mixed gas of mercury and at least one kind of gas selected from a group consisting of a noble gas and hydrogen.

6. The electrode for the discharge lamp as claimed in claim 1, wherein the mayenite compound includes a 12CaO—7Al₂O₃ compound, a 12SrO—7Al₂O₃ compound, a mixed crystal compound of those, or an isomorphic compound of those.

7. The electrode for the discharge lamp as claimed in claim 1, wherein at least a part of free oxygen ions forming the mayenite compound is substituted by anions of atoms having an electron affinity smaller than that of the free oxygen ions.

8. The electrode for the discharge lamp as claimed in claim 7, wherein the anions of the atoms having the electron affinity smaller than that of the free oxygen ions are hydride ions H⁻.

9. The electrode for the discharge lamp as claimed in claim 8, wherein a H⁻ ion density of the hydride ions H⁻ is 1×10¹⁵ cm⁻³ or higher.

10. A discharge lamp comprising:
the electrode for the discharge lamp as claimed in claim 1.

11. A method of manufacturing an electrode for a discharge lamp, comprising:
forming a part of the electrode or the electrode in its entirety by a mayenite compound, and thereafter plasma treating a surface of a surface layer of the mayenite compound of the electrode.

12. A discharge lamp comprising:
the electrode for the discharge lamp manufactured by the method as claimed in claim 11.

13. A discharge lamp comprising:
an fluorescent tube;
a discharge gas sealed inside the fluorescent tube; and
a mayenite compound in contact with the discharge gas and arranged in at least a part inside the fluorescent tube,
wherein a surface of a surface layer of the mayenite compound is plasma treated.
